(19) United States
(12) Patent Application Publication
(10) Pub. No.: US 2015/0066634 A1
(43) Pub. Date: Mar. 5, 2015

(54) SYSTEM, A METHOD AND A COMPUTER PROGRAM PRODUCT FOR OPTIMALLY COMMUNICATING BASED ON USER'S HISTORICAL INTERACTIONS AND PERFORMANCE DATA

(71) Applicant: KENSHOO LTD., Tel Aviv (IL)

(72) Inventors: Gilad ARMON-KEST, Amirim (IL); Eyal SADEH, Herzelia (IL); Itai MARKS, Tel Aviv (IL); Tal HASSON, Petach Tikva (IL)

(73) Assignee: KENSHOO LTD., Tel Aviv (IL)

(21) Appl. No.: 14/018,669

(22) Filed: Sep. 5, 2013

(51) Int. Cl. G06Q 30/02

(52) U.S. Cl. CPC G06Q 30/0269; G06Q 30/0246; G06Q 30/0275
USPC 705/14.45; 705/14.66; 705/14.54

(57) ABSTRACT

Provided is a system for communication, including: a non-transitory processor configured to: (a) determine a group of messages including a plurality of optional messages for a user in response to obtaining of user identification information identifying the user; (b) obtain performance information for each one of plurality of optional messages; (c) obtain historical interactions data pertaining to interactions which are included in a series of user interactions, where at least one of the interactions of the series includes communication of digital media over a network connection to the user; and (d) select an elect message out of the plurality of optional messages based on the historical interactions data and on the performance information; and a communication interface operable and configured to transmit information of the elect message over a communication channel.

### TECHNICAL FIELD

The presently disclosed subject matter relates to the field of communication, and more specifically to communication of digital media.

### BACKGROUND

Publications considered to be relevant as background to the presently disclosed subject matter are listed below. Acknowledgement of the publications herein is not to be inferred as meaning that these are in any way relevant to the patentability of the presently disclosed subject matter.

Patent Cooperation Treaty (PCT) patent application serial number PCT/CA2011/001418 (publication number WO 2012088596 A1) entitled “System and method for real-time search re-targeting” discloses a computer network implemented system and method for managing an Internet advertising campaign. The method includes the steps of identifying, generating, or obtaining attributes of an ad campaign including keywords and optionally including consumer attributes (“ad campaign data”); establishing a consumer profile for each of a pool of consumers, the consumer profile including recent search history obtained on an anonymous basis; comparing the ad campaign data to the consumer profiles so as to identify a consumer audience segment; and bidding real-time for access to display advertising impressions associated with the consumer audience segment so as to enable re-targeting of the consumer audience segment based on the ad campaign data using display advertising. The system includes a data logging utility, a re-targeting utility and a real time bidding infrastructure. A real time bidding method is also provided.

U.S. patent application serial number 20130212108, entitled “System, a Method and a Computer Program Product for Performance Assessment” (publication number US2013212108A) discloses a system, a computerized method, and a computer program product for classification of items based on their attributes and on a classification scheme that is defined based on information pertaining to each item of a set of items, and which is indicative of: (a) a quantity of occurrences of the item in a sample; (b) a quantity of successful occurrences of the item in the sample; and (c) at least one attribute of the item with regard to at least one variable out of a set of variables.

U.S. patent application serial number 20120692071, entitled “System, Method and Computer Program Product for Prediction Based on User Interactions History” (publication number US2013204700) discloses a system operable to computing a performance assessment, the system including: an interface, configured to obtain information of interactions which are included in a series of interactions, wherein at least one of the interactions of the series includes communication of digital media over a network connection; and a processor on which a performance assessment module is implemented, the performance assessment module is configured to compute a performance assessment for the series of interactions, based on the obtained information and on an assessment scheme which is based on a statistical analysis of historical data of a plurality of series of interactions.

### General Description

In accordance with certain aspects of the presently disclosed subject matter, there is provided a computerized method for communication with a user, including:
in response to obtaining of user identification information identifying the user, determining a group of messages including a plurality of optional messages for the user;
obtaining performance information for each one of plurality of optional messages;
obtaining historical interactions data pertaining to interactions which are included in a series of user interactions, wherein at least one of the interactions of the series includes communication of digital media over a network connection to the user; and
selecting an elect message out of the plurality of optional messages based on the historical interactions data and on the performance information; and
transmitting information of the elect message over a communication channel.

In accordance with certain embodiments of the presently disclosed subject matter, there is further provided a computerized method for advertising, the method including:
obtaining from a real-time bidding (RTB) server a bidding request for a bid for displaying an advertisement to the user, and obtaining the user identification which is associated with the bidding request; and
executing the computerized method for transmitting information of the elect message, wherein the elect message is an advertisement selected out of a group of advertisements based on the historical interactions data.

In accordance with certain embodiments of the presently disclosed subject matter, there is further provided a method, wherein the determining of the group of messages is based on information from the historical interactions data which is indicative of at least one query submitted by the user.

In accordance with certain embodiments of the presently disclosed subject matter, there is yet further provided a method, wherein the determining of the group of messages is based on the historical interactions data.

In accordance with certain embodiments of the presently disclosed subject matter, there is yet further provided a method, wherein the determining of the group of messages is based on the historical interactions data which includes data pertaining to webpages accessed by the user and to at least one query submitted by the user.

In accordance with certain embodiments of the presently disclosed subject matter, there is yet further provided a method, wherein the determining of the group of messages is based on past visits of the user to one or more identified websites.

In accordance with certain embodiments of the presently disclosed subject matter, there is yet further provided a method, wherein the plurality of optional messages may include messages from two or more non-overlapping sets of messages, wherein the selecting of the elect message is based on times at which messages of different sets from the non-overlapping sets of messages were communicated to the user.

In accordance with certain embodiments of the presently disclosed subject matter, there is yet further provided a method, wherein different valuations are assigned to different optional messages out of the plurality of optional messages wherein the selecting of the elect message is further based on the valuations assigned to the plurality of optional messages.

In accordance with certain embodiments of the presently disclosed subject matter, there is yet further provided a method, further including assigning the valuations to the plurality of optional messages, wherein the assigning is based on the historical interactions data.

In accordance with certain embodiments of the presently disclosed subject matter, there is yet further provided a method, further including determining a bid for the elect message based on at least one of: (a) the historical interactions data and (b) the performance information, wherein the transmitting further includes transmitting the bid.

In accordance with certain embodiments of the presently disclosed subject matter, there is yet further provided a method, wherein the determining further includes determining the bid for the elect message based on: (a) the historical interactions data and (b) the performance information.

In accordance with certain embodiments of the presently disclosed subject matter, there is yet further provided a method, wherein the group of messages includes advertisable entities; wherein the performance information includes click-through rate (CTR) information for each one of the plurality of optional advertisable entities; wherein the historical interactions data includes data pertaining to advertisements previously communicated to the user; wherein the elect message is an elect advertisement; wherein the transmitting includes transmitting to a real-time bidding server a bid for displaying the elect advertisement to the user.

In accordance with certain embodiments of the presently disclosed subject matter, there is yet further provided a method, including: for each label out of a set of labels, obtaining a conversion-rate estimation and a conversion value estimation; determining a valuation for the label based on the conversion-rate estimation and on the conversion value estimation; and choosing out of the set of labels at least one label as a user-associated label based on the historical interactions data; wherein the selecting of the elect message is responsive to the at least one user-associated label.

In accordance with certain embodiments of the presently disclosed subject matter, there is yet further provided a method, wherein the obtaining of the conversion-rate estimation for each one of the set of labels includes:
storing in a storage apparatus information pertaining to each label out of the set of labels, the information being indicative of: (a) a quantity of occurrences of the label in a sample; (b) a quantity of conversions of the label in the sample; and (c) at least one attribute of the label with regard to at least one variable out of a set of variables; wherein the quantity of occurrences of at least one of the labels is larger than one;
defining a classification scheme for classification of labels into classes based on at least one of the variables; wherein the defining of the classification scheme includes assigning a score to a variable out of the at least one variable, based on a plurality of quantities of conversions of labels, each of the quantities is a quantity of conversions having a corresponding attribute out of a plurality of attributes of the variable;
applying the classification scheme to attributes of a plurality of labels of the set, thereby obtaining for each one out of a plurality of the classes a respective subset of the plurality of labels;
determining, with respect to each class of the plurality of classes, an outcome estimation based on quantities of conversions of labels of the respective subset of labels of the class; and
computing for each label of the set of labels a conversion rate estimation which is based on an outcome estimation of a class out of the classes that is a result of application of the classification scheme to attributes of the analyzed label.

In accordance with certain embodiments of the presently disclosed subject matter, there is yet further provided a method, wherein the choosing of the least one user-associated label includes choosing between multiple labels which are associated with interactions of the series of interactions.

In accordance with certain embodiments of the presently disclosed subject matter, there is yet further provided a method, including: for at least one of the plurality of optional messages, determining a valuation for that optional message based on timing of one or more interactions of the series of user interactions.

In accordance with certain embodiments of the presently disclosed subject matter, there is yet further provided a method, wherein the selecting of the elect message is preceded by receiving a plurality of requests, each of the requests including user identification information identifying a respective user, and, with respect to each one of the requests: (a) determining a respective group of messages which includes a respective plurality of optional messages for the respective user; (b) obtaining performance information for each one of the respective plurality of optional messages; (c) obtaining historical interactions data pertaining to interactions which are included in a respective series of user interactions associated with the respective user, wherein at least one of the interactions of the series includes communication of digital media over a network connection to the respective user; and (d) determining whether to initiate communication of any of the respective plurality of optional messages to the respective user; thereby determining not to initiate communication with any user as a result of at least one of the plurality of requests; wherein the selecting of the elect message is executed in response to determining to initiate communication with the user that is identified in at least one of the plurality of requests.

In accordance with certain embodiments of the presently disclosed subject matter, there is yet further provided a method, wherein user identification information that identifies the user is included in at least one early request out of the plurality of requests and in at least one later request out of the plurality of requests, wherein the method includes determining not to initiate communication with the user in response to the early request, and determining to initiate communication with the user in response to the later request.

In accordance with certain aspects of the presently disclosed subject matter, there is yet further provided a system for communication, including:
a non-transitory processor configured to:
   determine a group of messages including a plurality of optional messages for a user in response to obtaining of user identification information identifying the user,
   obtain performance information for each one of a plurality of optional messages;
   obtain historical interactions data pertaining to interactions which are included in a series of user interactions, wherein at least one of the interactions of the series includes communication of digital media over a network connection to the user; and
   select an elect message out of the plurality of optional messages based on the historical interactions data and on the performance information; and
a communication interface operable and configured to transmit information of the elect message over a communication channel.

In accordance with certain embodiments of the presently disclosed subject matter, there is yet further provided a system, wherein the system is an advertising system, wherein: (a) the processor is configured to select, based on the historical interactions data and on the performance information, an elect advertisement out of the group of messages which comprises a plurality of optional advertisement; and (b) the communication interface is configured and operable to obtain the user identification information identifying the user in a bidding request for a bid for displaying an advertisement to the user which is received from a real-time bidding (RTB) server; and to transmit information of the elect advertisement over the communication channel.

In accordance with certain embodiments of the presently disclosed subject matter, there is yet further provided a system, wherein the processor is configured to determine the group of messages based on at least one query submitted by the user.

In accordance with certain embodiments of the presently disclosed subject matter, there is yet further provided a system, wherein the processor is configured to determine the group of messages based on the historical interactions data.

In accordance with certain embodiments of the presently disclosed subject matter, there is yet further provided a system, wherein the plurality of optional messages may include messages from two or more non-overlapping sets of messages, wherein the processor is configured to select the elect message based on times at which messages of different sets from the non-overlapping sets of messages were communicated to the user.

In accordance with certain embodiments of the presently disclosed subject matter, there is yet further provided a system, wherein different valuations are assigned to different optional messages out of the plurality of optional messages; wherein the processor is configured to select the elect message further based on the valuations assigned to the plurality of optional messages.

In accordance with certain embodiments of the presently disclosed subject matter, there is yet further provided a system, wherein the processor is further configured to assign the valuations to the plurality of optional messages based on the historical interactions data.

In accordance with certain embodiments of the presently disclosed subject matter, there is yet further provided a system, wherein the processor is further configured to determine a bid for the elect message based on at least one of: (a) the historical interactions data and (b) the performance information, wherein the transmitting further includes transmitting the bid.

In accordance with certain embodiments of the presently disclosed subject matter, there is yet further provided a system, wherein the processor is configured to determine the bid for the elect message based on: (a) the historical interactions data and (b) the performance information.

In accordance with certain embodiments of the presently disclosed subject matter, there is yet further provided a system, wherein the processor is configured to: for each out of a set of labels, determine a conversion-rate estimation and a conversion value estimation, and determine a valuation for the label based on the conversion-rate estimation and on the conversion value estimation; and to choose out of the set of labels at least one label as a user-associated label based on the historical interactions data; wherein the processor is configured to select the elect message in response to the at least one user-associated label.

In accordance with certain embodiments of the presently disclosed subject matter, there is yet further provided a system, wherein the processor is operable and configured to receive a plurality of requests, each of the requests including user identification information identifying a respective user, and, with respect to each one of the requests:
(a) determining a respective group of messages which includes a respective plurality of optional messages for the respective user;
(b) obtaining performance information for each one of the respective plurality of optional messages;
(c) obtaining historical interactions data pertaining to interactions which are included in a respective series of user interactions associated with the respective user, wherein at least one of the interactions of the series includes communication of digital media over a network connection to the respective user; and
(d) determining whether to initiate communication of any of the respective plurality of optional messages to the respective user;
thereby determining not to initiate communication with any user as a result of at least one of the plurality of requests;
wherein the processor is operable and configured to select the elect message in response to determining to initiate communication with the user that is identified in at least one of the plurality of requests.

In accordance with certain aspects of the presently disclosed subject matter, there is yet further provided a non-volatile program storage device readable by machine, tangibly embodying a program of instructions executable by the machine to perform a method for communication with a user which includes the steps of:
in response to obtaining of user identification information identifying the user, determining a group of messages including a plurality of optional messages for the user;
obtaining performance information for each one of plurality of optional messages;
obtaining historical interactions data pertaining to interactions which are included in a series of user interactions, wherein at least one of the interactions of the series includes communication of digital media over a network connection to the user; and
selecting an elect message out of the plurality of optional messages based on the historical interactions data and on the performance information; and
transmitting information of the elect message over a communication channel.

In accordance with certain embodiments of the presently disclosed subject matter, there is yet further provided a program storage device, wherein the determining of the group of messages is based on information from the historical interactions data which is indicative of at least one query submitted by the user.

In accordance with certain embodiments of the presently disclosed subject matter, there is yet further provided a program storage device, wherein the determining of the group of messages is based on the historical interactions data.

In accordance with certain embodiments of the presently disclosed subject matter, there is yet further provided a program storage device, wherein the determining of the group of messages is based on the historical interactions data which includes data pertaining to webpages accessed by the user and to at least one query submitted by the user.

In accordance with certain embodiments of the presently disclosed subject matter, there is yet further provided a program storage device, wherein the determining of the group of messages is based on past visits of the user to one or more identified websites.

In accordance with certain embodiments of the presently disclosed subject matter, there is yet further provided a program storage device, wherein the plurality of optional messages may include messages from two or more non-overlapping sets of messages, wherein the selecting of the elect message is based on times at which messages of different sets from the non-overlapping sets of messages were communicated to the user.

In accordance with certain embodiments of the presently disclosed subject matter, there is yet further provided a program storage device, wherein different valuations are assigned to different optional messages out of the plurality of optional messages wherein the selecting of the elect message is further based on the valuations assigned to the plurality of optional messages.

In accordance with certain embodiments of the presently disclosed subject matter, there is yet further provided a program storage device, further including instructions for assigning the valuations to the plurality of optional messages, wherein the assigning is based on the historical interactions data.

In accordance with certain embodiments of the presently disclosed subject matter, there is yet further provided a program storage device, further including instructions for determining a bid for the elect message based on at least one of: (a) the historical interactions data and (b) the performance information, wherein the transmitting further includes transmitting the bid.

In accordance with certain embodiments of the presently disclosed subject matter, there is yet further provided a program storage device, wherein the determining further including determining the bid for the elect message based on: (a) the historical interactions data and (b) the performance information.

In accordance with certain embodiments of the presently disclosed subject matter, there is yet further provided a program storage device, wherein the group of messages includes advertisable entities;
wherein the performance information includes click-through rate (CTR) information for each one of the plurality of optional advertisable entities;
wherein the historical interactions data includes data pertaining to advertisements previously communicated to the user;
wherein the elect message is an elect advertisement;
wherein the transmitting includes transmitting to a real-time bidding server a bid for displaying the elect advertisement to the user.

In accordance with certain embodiments of the presently disclosed subject matter, there is yet further provided a program storage device, including instructions for:
for each label out of a set of labels, obtaining a conversion-rate estimation and a conversion value estimation;
determining a valuation for the label based on the conversion-rate estimation and on the conversion value estimation; and
choosing out of the set of labels at least one label as a user-associated label based on the historical interactions data;
wherein the selecting of the elect message is responsive to the at least one user-associated label.

In accordance with certain embodiments of the presently disclosed subject matter, there is yet further provided a program storage device, wherein the obtaining of the conversion-rate estimation for each one of the set of labels includes:
storing in a storage apparatus information pertaining to each label out of the set of labels, the information being indicative of: (a) a quantity of occurrences of the label in a sample; (b) a quantity of conversions of the label in the sample; and (c) at least one attribute of the label with regard to at least one variable out of a set of variables; wherein the quantity of occurrences of at least one of the labels is larger than one;
defining a classification scheme for classification of labels into classes based on at least one of the variables; wherein the defining of the classification scheme includes assigning a score to a variable out of the at least one variable, based on a plurality of quantities of conversions of labels, each of the quantities is a quantity of conversions having a corresponding attribute out of a plurality of attributes of the variable;
applying the classification scheme to attributes of a plurality of labels of the set, thereby obtaining for each one out of a plurality of the classes a respective subset of the plurality of labels;
determining, with respect to each class of the plurality of classes, an outcome estimation based on quantities of conversions of labels of the respective subset of labels of the class; and
computing for each label of the set of labels a conversion rate estimation which is based on an outcome estimation of a class out of the classes that is a result of application of the classification scheme to attributes of the analyzed label.

In accordance with certain embodiments of the presently disclosed subject matter, there is yet further provided a program storage device, wherein the choosing of the at least one user-associated label includes choosing between multiple labels which are associated with interactions of the series of interactions.

In accordance with certain embodiments of the presently disclosed subject matter, there is yet further provided a program storage device, including instructions for: for at least one of the plurality of optional messages, determining a valuation for that optional message based on timing of one or more interactions of the series of user interactions.

In accordance with certain embodiments of the presently disclosed subject matter, there is yet further provided a program storage device, wherein the selecting of the elect message is preceded by receiving a plurality of requests, each of the requests including user identification information identifying a respective user, and wherein the program storage device further includes instructions with respect to each one of the requests, for:
(a) determining a respective group of messages which includes a respective plurality of optional messages for the respective user;
(b) obtaining performance information for each one of the respective plurality of optional messages;
(c) obtaining historical interactions data pertaining to interactions which are included in a respective series of user interactions associated with the respective user, wherein at least one of the interactions of the series includes communication of digital media over a network connection to the respective user; and
(d) determining whether to initiate communication of any of the respective plurality of optional messages to the respective user;
thereby determining not to initiate communication with any user as a result of at least one of the plurality of requests;
wherein the selecting of the elect message is executed in response to determining to initiate communication with the user that is identified in at least one of the plurality of requests.

In accordance with certain embodiments of the presently disclosed subject matter, there is yet further provided a program storage device, wherein user identification information that identifies the user is included in at least one early request out of the plurality of requests and in at least one later request out of the plurality of requests, wherein the program storage device includes instructions for determining not to initiate communication with the user in response to the early request, and determining to initiate communication with the user in response to the later request.

In accordance with certain embodiments of the presently disclosed subject matter, there is yet further provided a non-volatile program storage device readable by machine, tangibly embodying a program of instructions executable by the machine to perform a method for advertising to a user which comprises the steps of: (a) obtaining from a real-time bidding (RTB) server a bidding request for a bid for displaying an advertisement to the user, and obtaining the user identification which is associated with the bidding request; and executing any combination of any one or more of the above steps of the program of instructions, for transmitting information of the elect message, wherein the elect message is an advertisement selected out of a group of advertisements based on the historical interactions data.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a generalized flow chart of a computerized method for communication with a user, in accordance with the subject matter of the present invention;

FIG. 2 is a generalized flow chart of a computerized method which implements the method of FIG. 1 for communication of digital media with a user, in accordance with the subject matter of the present invention;

FIG. 3 is a generalized flow chart of the method of FIG. 1 in accordance with the subject matter of the present invention;

FIG. 4 is a generalized flow chart of the method of FIG. 1, which is a computerized method for communication with a user, in accordance with the subject matter of the present invention;

FIG. 5 is a generalized flow chart of a process for assigning a valuation to the user, in accordance with the subject matter of the present invention;

FIG. 6 is a generalized flow chart of a process for executing a stage of the method of FIG. 5, in accordance with the subject matter of the present invention;

FIG. 7 is a functional block diagram of system 200, which is a system for communication in accordance with the presently disclosed subject matter;

FIGS. 8A and 8B illustrate series of user interactions, in accordance with the presently disclosed subject matter; and

FIG. 9 is a generalized flow chart of a computerized method which implements the method of FIG. 1 for communication of digital media with a user, in accordance with the subject matter of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known features, structures, characteristics, stages, methods, procedures, modules, components and systems, have not been described in detail so as not to obscure the present invention.

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, or the like, include action and/or processes of a computer that manipulate and/or transform data into other data, the data represented as physical quantities, e.g. such as electronic quantities, and/or the data representing the physical objects. The terms “computer”, “processor”, and “controller” should be expansively construed to cover any kind of electronic device with data processing capabilities, including, by way of non-limiting example, or a part thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein the term “memory” refers to any readable medium for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

Optional: Reference in the specification to “one embodiment”, “an embodiment”, “some embodiments”, “another embodiment”, “other embodiments”, “some other embodiments”, “one instance”, “an instance”, “some instances”, “another instance”, “other instances”, “some other instances”, “one case”, “a case”, “some cases”, “another case”, “other cases”, “some other cases”, or variants thereof means that a particular feature, structure, characteristic, stage method, module described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments”, “some other embodiments, “one instance”, “an instance”, “some instances”, “another instance”, “some other instances”, “one case”, “a case”, “some cases”, “another case”, “other cases”, “some other cases”, or variants thereof does not necessarily refer to the same embodiment(s).

Embodiments of the presently disclosed subject matter are not described with reference to any particular programming language. It will be appreciated that a variety of programming languages may be used to implement the teachings of the presently disclosed subject matter as described herein.

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Any trademark occurring in the text or drawings is the property of its owner and occurs herein merely to explain or illustrate one example of how the presently discussed subject matter may be implemented.

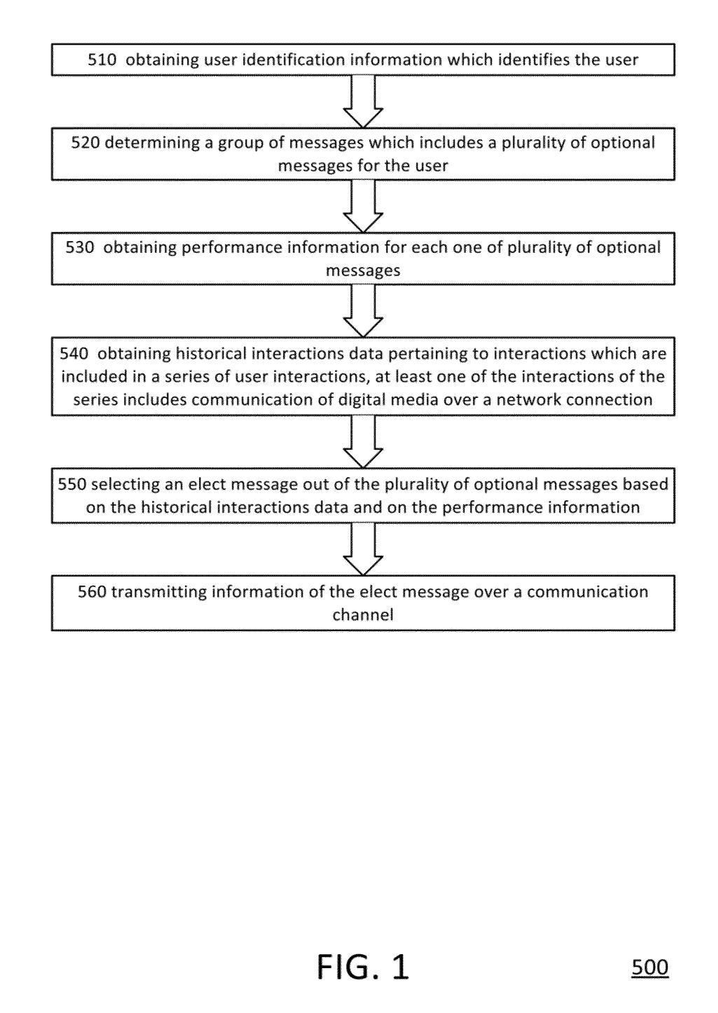

FIG. 1 is a generalized flow chart of method 500, which is a computerized method for communication with a user, in accordance with the subject matter of the present invention. Referring to the examples set forth with respect to other drawings of this disclosure, method 500 may be carried out by a system such as system 200, and especially by one or more processing modules thereof (each implemented by at least one tangible hardware processor).

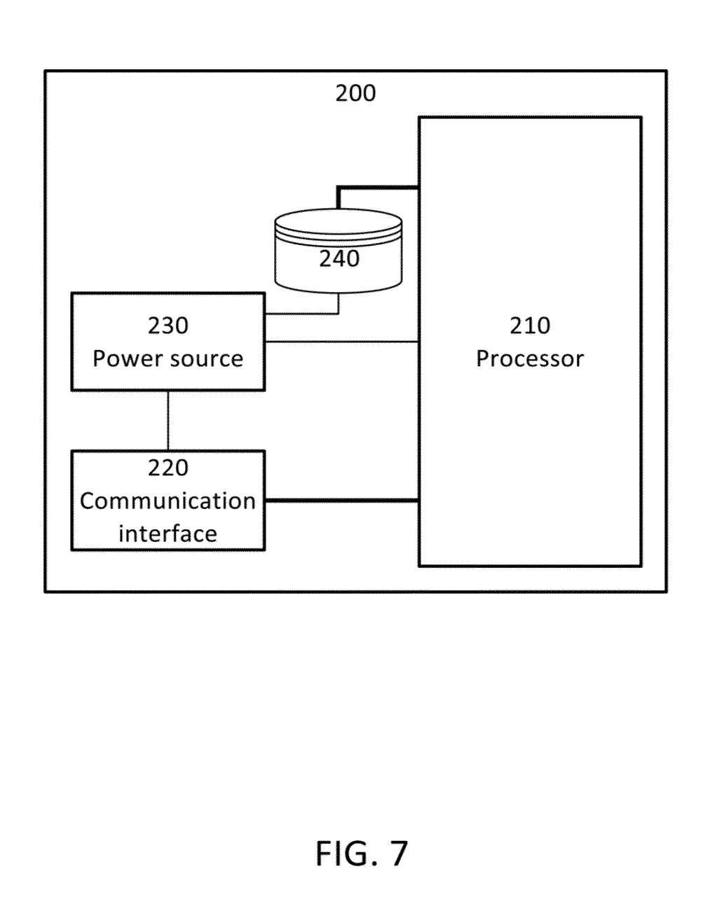

Referring to the examples set forth in FIG. 7, method 500 may be executed by a system such as system 200. Embodiments, variations and possible implementations discussed with relation to method 500 may be applied to system 200 mutatis mutandis even if not explicitly elaborated, and vice versa.

Stage 510 includes obtaining user identification information which identifies the user which is communicated in method 500. The obtaining of stage 510 may be originated by system 200 (e.g. by processing a dataset of users, and selecting the user identification information of the user) or by an external system. For example, the user identification information may be obtained in a request for data received from a remote system over a network connection such as the Internet, an intranet, and so on. Referring to the examples set forth with respect to the previous drawings, stage 510 may be carried out by processor 210.

It is noted that the user may be a human user (e.g. identified by his social security number or username), and may also be a computer, a processor or another electronic communication device (e.g. identified by its Internet protocol (IP) address, its media access control (MAC) address, a cookie installed on it, etc.).

Stage 520 of method 500 is executed in response to obtaining of the user identification information (which identifies the user), and includes determining a group of messages which includes a plurality of optional messages for the user. The determining of the group of messages in stage 520 may include obtaining the group as a predetermined group (e.g. retrieving the group or identifier thereof from a database entry which is associated with the user identification), but may also include selecting the plurality of optional messages out of a larger group of messages which are not necessarily associated with the user or the user identification information.

The number of messages in the group of messages may differ in different implementations of the invention, or in different execution cycles of a single implementation. For example, the group of messages may include individual messages (e.g. two, three, four or more), but may also include dozens, hundreds, or more messages. Referring to the examples set forth with respect to the previous drawings, stage 520 may be carried out by processor 210.

The determining of the group of messages in stage 520 may also depend on additional information, whether associated with the user (or the user identification information) or not. For example, the determining of stage 520 may also depend on additional factors such as: what messages were previously sent to this user and/or to other users, what are the characteristics of the user (whether known or estimated), what are the requirements of the system issuing the messages, what is the cost associated with each of the optional messages, and so on.

It is noted that different types of optional messages may be implemented for different reasons. For example, the optional messages may be used to inform the user (e.g. of a status of the system issuing the system, of a data entry stored by the system which is associated with the user, sending files of information to the user, and so on), to request information from the user, to present to the user alternatives from which to select (e.g. with which communication ports of the system issuing the messages the user may communicate), and so on. Some types of messages are discussed below in greater detail.

Stage 530 of method 500 includes obtaining performance information for each one of a plurality of optional messages. The performance information may be indicative of the performances of the optional messages themselves, or of actions or events which are associated with the messages. It is noted that the performance information for an optional message may be indicative of performance of that optional message (or of similar messages) in the past and/or of estimations of the likely performance of this optional message in the future. The obtaining of stage 530 may include receiving the performance information from a database and/or from an external system, and may also include computing or otherwise generating the performance information. Referring to the examples set forth with respect to the previous drawings, stage 530 may be carried out by processor 210.

In but a few examples—
a. If the optional message is a payload of information to be transmitted to the user over an unreliable communication channel, the performance information obtained for the optional message may be indicative of the likelihood of the transmission of the optional message to the user, the time it may take to transmit the optional message, and/or the costs which such transmission is expected to incur.
b. If the optional message is an instruction or a suggestion to the user to execute an action, the performance information obtained for it may be indicative of the likelihood of the action to be executed by the user, the expected benefit from the execution of the action, and so on.
c. If the optional message identifies a hardware or software component which may be made available for the user, the performance information obtained for it may be indicative of the value of the component for the user, the cost which the utilization of the component by the user may incur, and so on.

Stage 540 of method 500 includes obtaining historical interactions data pertaining to interactions which are included in a series of user interactions, at least one of the interactions of the series including communication of digital media over a network connection. It is noted that at least one of the interactions of the series (and possibly all of them) include interactions with the user. Referring to the examples set forth with respect to the previous drawings, stage 540 may be carried out by processor 210. It is noted that the interactions of the series may be connected to one another (e.g. a later interaction may be the result of one or more former interactions of the series), but this is not necessarily so. Some examples of historical interactions data which may be obtained with respect to the interactions of the series are provided below.

Stage 550 of method 500 includes selecting a message (hereinbelow referred to as “the elect message”) out of the plurality of optional messages based on the historical interactions data and on the performance information. It is noted that the selection of the elect message may be based on additional factors as well, but it is based on at least the two aforementioned and possibly unrelated data types: the performance information obtained for the plurality of optional messages, and the historical interactions data which pertains to the historical series of interactions. Referring to the examples set forth with respect to the previous drawings, stage 550 may be carried out by processor 210.

Stage 560 of method 500 includes transmitting information of the elect message over a communication channel. Stage 560 may include transmitting the elect message itself (e.g. the information of the elect message transmitted is a content of the elect message) or information pertaining to it (e.g. an identifier of the elect message may be transmitted, thereby enabling another system to transmit the elect message to the user). Referring to the examples set forth with respect to the previous drawings, stage 560 may be carried out by communication interface 220.

It is noted that the computations of stage 550 may optionally also conclude—in some implementations—in a decision not to select any one of the optional messages as an elect message. For example, if in view of the performance information and the historical interactions data it is concluded that none of the optional messages has an expectation of success which exceeds a threshold, the computations of stage 550 may result in a decision not to continue to a selection of an elect message.

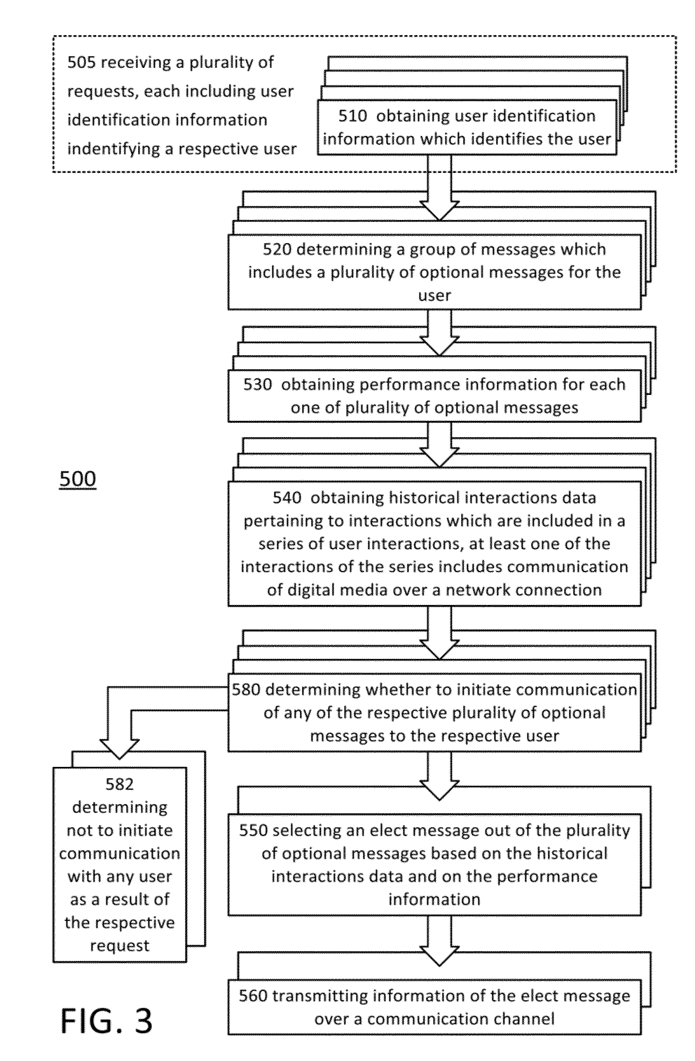

FIG. 3 is a generalized flow chart of method 500 in accordance with the subject matter of the present invention. While not necessarily so, stages 510, 520, 530, and 540 may be iterated several times before actually selecting a message to be transmitted to any user. It is noted that a cost resulting from deciding to transmit a message to a user may be significant (because of the cost of the actual transmission, e.g. if communication costs are significant, and/or because of costs of the action which may follow such a transmission, e.g. costs of advertisements authorized by a bid made to a real-time bidding server). At other times, sending of a message to a user may not be the most effective way to achieve the goal for which the message is intended.

Optionally, the obtaining of the user identification information in stage 510 may be implemented by receiving a request which includes user identification information which identifies one out of many users whose user identification information is identifiable by a system which executes method 500. This stage of receiving is repeated several times (denoted stage 505)—possibly at different times (e.g. over hours, days, etc.), thereby receiving a plurality of requests, each of the requests including user identification information identifying a respective user.

Stages 520, 530 and 540 are executed with respect to each one of these requests, thereby executing for each of the requests: (a) determining a respective group of messages which includes a respective plurality of optional messages for the respective user (stage 520); (b) obtaining performance information for each one of the respective plurality of optional messages (stage 530); and (c) obtaining historical interactions data pertaining to interactions which are included in a respective series of user interactions associated with the respective user, wherein at least one of the interactions of the series includes communication of digital media over a network connection to the respective user (stage 540).

The information accumulated with respect to each of the requests in these stages is sufficient to select an elect message in response to each of these requests (e.g. as discussed with respect to FIG. 1), but may also be used to determine when to refrain from transmitting any messages in response to some of the requests, e.g. as discussed above.

Therefore, with respect to each of the requests received in stage 580, they include determining whether to initiate communication of any of the respective plurality of optional messages to the respective user.

This results in determining not to initiate communication with any user as a result of at least one of the plurality of requests (denoted stage 582), and for other requests (at least one) continuing with executing stages 550 and 560. The selecting of the elect message in such a case is executed in response to determining to initiate communication with the user that is identified in at least one of the plurality of requests.

It is noted that the same user may be identified in several requests. For example, if the method of FIG. 3 is used for real-time bidding (as discussed with respect to method 600), bid requests may be received as the result of visits of the same user to several websites, as a result of multiple visits of the same user to a particular website, or as a result of multiple requests (for different ad spots) for a single visit of the same user. It is noted that in some instances it may be determined in stage 580 not to advertise to the user, while in some other instances it may be determined that advertising to the user is beneficial and should therefore be conducted.

It is also noted that different messages may be selected for the user at different times. This may result in changes in the historic interaction data (e.g. the intent of the user may differ at different times), but may also be the result of a deliberate action. Even if the user is still searching for the same product (e.g. dog food), it may be considered ineffective to advertise to this user the same product numerous times, and therefore another product may be advertised (e.g. a product of general interest to this user, such as a music CD).

More generally, user identification information that identifies the user may be included in at least one early request out of the plurality of requests and in at least one later request out of the plurality of requests. In such cases, method 500 may include determining not to initiate communication with the user in response to the early request, and determining to initiate communication with the user in response to the later request.

Optionally, the user interaction which triggered the early request (e.g. the visiting of a certain website by the user) and possibly the communicating of the elect message (e.g. advertisement) to the user as a result (if it occurred) may be included in the series of user interactions obtained (step 530) and analyzed for determining how to react to the later request.

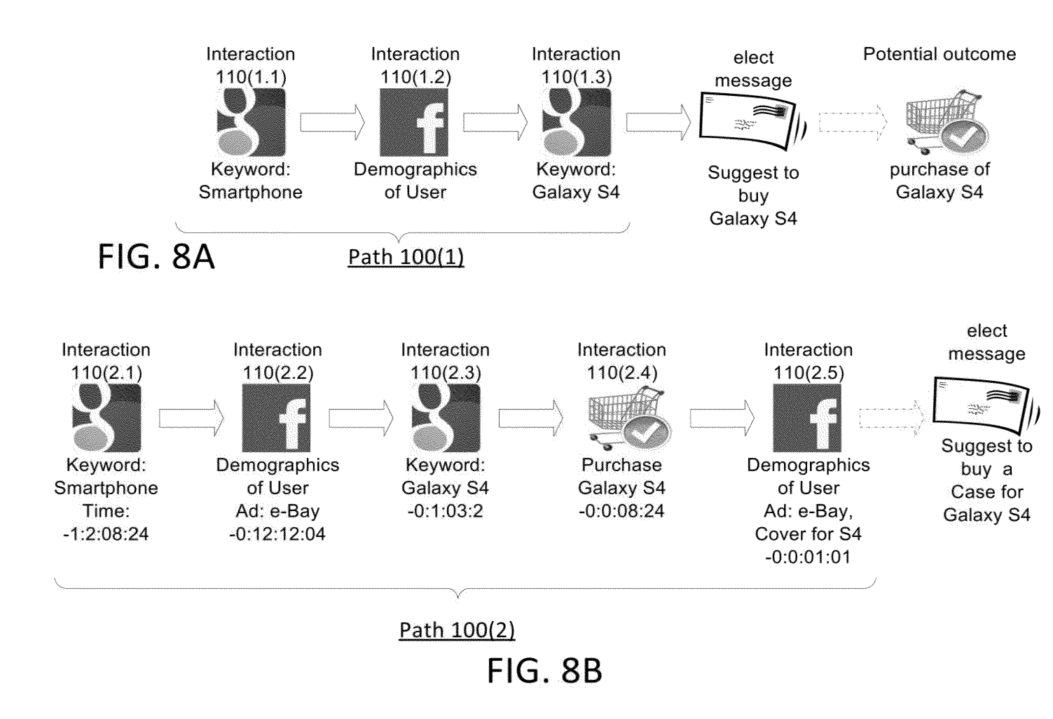

The time between the occurrences of each user interaction of the series to the time of the request is exemplified in FIG. 8B. However, other formats of storing and utilizing the timestamps may also be used. For example, the timing of the interactions of the series may be used as an indication to the relevancy of the data of these interactions. For example, the longer it has been since the user searched for a given product, the less likely it may be that the user is going to purchase this item if a relevant advertisement is presented.

It is noted that the decision to communicate to the user different messages at different times may be facilitated by assigning the value to the user, the series of user interactions and/or to one or more of the plurality of optional messages based on an analysis of the historic interactions data. Some of the ways in which such an analysis may be made are discussed in U.S. patent application serial number 20120692071, entitled “System, Method and Computer Program Product for Prediction Based on User Interactions History” (publication number US2013204700), which is incorporated herein by reference in its entirety.

It is noted that method 500 may be implemented for efficient utilization of communication and/or advertising resources (e.g., as part of stage 560). Such an efficient utilization of communication resources may be a result of transmitting to the user an efficient message and/or by efficiently transmitting the message to the user.

For example, the efficient utilization of communication resources (which may include advertising resources, communication hardware resources, communication channel resources, and so on), enabled by the selecting of stage 650 may include reducing an amount of data communicated to the user, thereby reducing an amount of communication resources. For example, parameters of the user, and/or of a posterior possible interaction with the user may be analyzed based on the results of the computing (e.g., based on the database referred to in the context of stage 550). If a result of the analysis is that a given interaction with the user at that opportunity should be limited or altogether avoided, a clear reduction in communication costs (financial, datalink, processing power, etc.) is obtained.

Efficient utilization of communication or advertising resources may also be achieved by better targeting the user with targeted advertising in view of the computed performance assessment (e.g., based on the database referred to in the context of stage 550).

It is noted that in addition to regular uses of the term “efficiency” and its derivative forms (e.g., “efficiently”), the term as used herein should be expansively construed to cover ways of putting the relevant resources into good, thorough, and/or careful use, especially regarding the utilization of these resources (thereby consuming a relatively small amount of such resources for providing a desirable outcome).

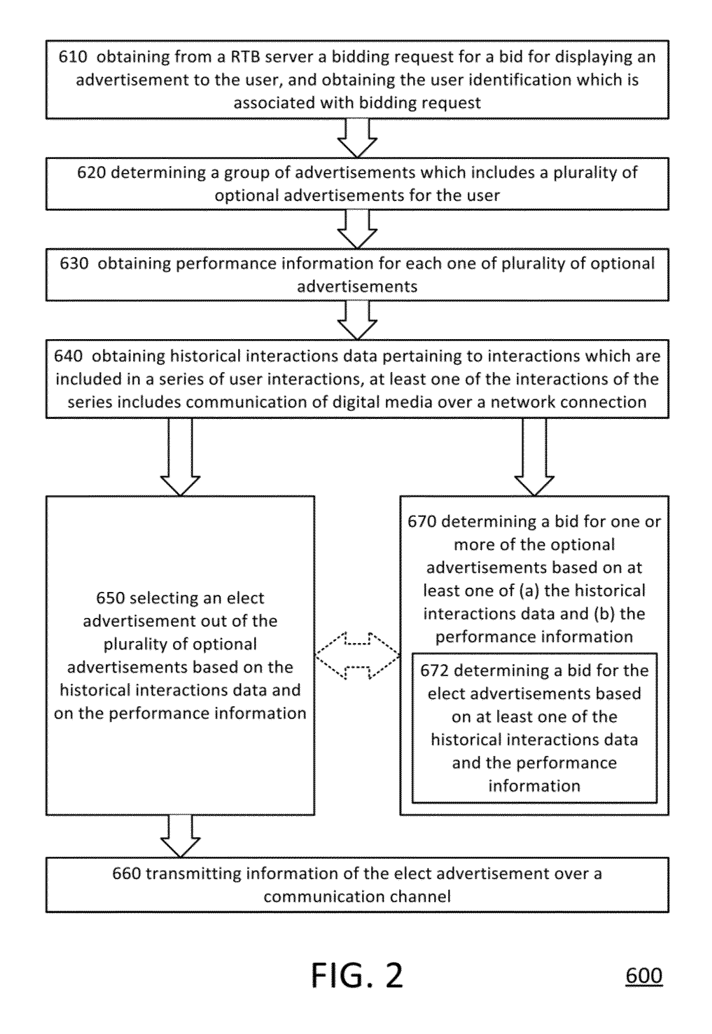

FIG. 2 is a generalized flow chart of a method of 600, which is a computerized method which implements method 500 for communication of digital media with a user, in accordance with the subject matter of the present invention. The digital media communicated to the user in method 600 may include, for example, text, one or more images, video, audio, or any combination of the above. For example, the digital media communicated to the user may be an advertisement which includes any one or more of the aforementioned media types, and method 600 may be implemented as a method for advertising. The discussion of method 600 below assumes that the optional messages are advertisements, but it will be clear to a person who is of skill in the art that other types of digital media messages may be used instead, mutatis mutandis.

Referring to the examples set forth in FIG. 7, method 600 may be executed by a system such as system 200. Embodiments, variations and possible implementations discussed with relation to method 600 may be applied to system 200 mutatis mutandis even if not explicitly elaborated, and vice versa.

It is noted that method 600 is one of many optional utilizations of method 500, and that its stages correspond to those of method 500. Stage 610 is a variation of stage 510, stage 620 is a variation of stage 520, stage 630 is a variation of stage 530, stage 640 is a variation of stage 540, stage 650 is a variation of stage 550, and stage 660 is a variation of stage 560. Therefore, all variations which are discussed with respect to stage 5XX of method 500 are also applicable to the corresponding stage of method 600, stage 6XX, and vice versa.

Stage 610 includes obtaining from a real-time bidding (RTB) server a bidding request for a bid for displaying an advertisement to the user, and obtaining the user identification which is associated with a bidding request.

By way of example, the process which may lead to the obtaining of the bidding request from the RTB server may be as follows:

A browser of the user requests a webpage of a site that uses real time bidding, and consequentially the browser receives the HTML for the webpage, which includes an embedded URL tag for an ad request. Based on the URL tag, the browser makes a call out to an ad server.

The ad server calls out a Supply Side Platform (SSP) used by the respective website. Alternatively, the SSP and the ad server may be integrated. Consequentially, the SSP makes a call out to at least one ad exchange.

The ad exchange (which serves as the RTB server of method 600) makes multiple bid requests to several Demand Side Platforms (DSPs), e.g. trying to get the best price (or, trying to get the maximal expected revenue). In such a case the system which executes method 600 may be one of these DSPs.

Following the reception of the bidding request from the RTB server, the other stages of method 500 may be executed for transmitting information of the elect message. As aforementioned, the elect message in this case may be an advertisement selected out of a group of advertisements based on the historical interactions data.

Stage 620 of method 600 includes determining a group of advertisements which include a plurality of optional advertisements for the user. It is noted that determining of the group of advertisements may be implemented by selecting (or possibly even generating) individual optional advertisements and/or by selecting (or possibly even generating) groups of advertisements. Such a group of advertisements may include variations of a single advertisement (e.g. the same content in different sizes and/or resolutions). Such a group of advertisements may also include a campaign (which in turn may include several advertisements).

Stage 630 of method 600 includes obtaining performance information for each one of a plurality of optional advertisements. For example, stage 630 may include obtaining for each of the plurality of optional advertisements as the performance information a historical click-through rate (CTR) or an estimated click through rate. The performance information obtained may be relevant for all of the users who viewed this advertisement, or only to a subgroup of the users to which the user belong (e.g. based on demographics—users in the United States older than 35).

The performance information may be obtained for individual optional advertisements or for a group of advertisements (e.g. for optional campaigns), from which the performance information for individual information may be deduced.

Other types of performance information may also be used, such as—by way of example—conversion rate. In Internet marketing, conversion rate is the ratio of visitors who convert casual content views or website visits into desired actions based on subtle or direct requests from marketers, advertisers, and content creators. Examples of conversion actions might include making an online purchase or submitting a form to request additional information. The conversion rate may be defined as the ratio between the number of goal achievements (e.g. number of purchases made) and the visits to the website (which may have resulted from ads displayed in response to the specific keywords). For example, a successful conversion may constitute the sale of a product to a consumer whose interest in the item was initially sparked by clicking on a banner advertisement.

The performance information may also be an assessment of the number of future interactions expected before a conversion is reached (or even before a valid estimation that a conversion may be/may not be expected, is reached), of the time before a conversion (or like estimation point) is reached, of the cost before a conversion (or like estimation point) is reached, an assessment of the revenue from the conversion (e.g. which products is the user likely to end up buying), etc.

Stage 640 of method 600 includes obtaining historical interactions data pertaining to interactions which are included in a series of user interactions, at least one of the interactions of the series including communication of digital media over a network connection. Especially, one or more of the interactions of the series may include advertising to the user by an advertisement displayed to the user in a web page accessed by the user (e.g. using a PC Internet browser, a Smartphone Internet browser, and so on).

The series of user interactions (also referred to as “path”, a few examples of which are illustrated in FIGS. 8A and 8B) may include all of the interactions (of which data exists) with a single user (or with multiple users, especially of those which are related to each other, e.g., via one of the interactions), but other grouping conditions may also be applied. For example, the series may be limited only to interactions which occurred within a predefined time frame, only to interactions over preselected channels, only to interactions pertaining to a subgroup of advertised products but not to others, and so on.

One example of a series of interactions is a series of interactions which may optionally lead to a conversion (a path to conversion). For example, a conversion may be purchasing a product online, joining a mailing list, voting in a survey, “Like”-ing, “+1”-ing or “Tweet”-ing a page on a website, “Like”-ing a page on Facebook and so on. The series of interactions may not include all of the interactions of the marketer with the user. Some interactions may be irrelevant (e.g., the user may have searched for several unrelated products but only some of these interactions are relevant for an optional future purchase of a selected one of them), while some of the interactions may be unaccounted for (e.g., the user may have seen a billboard advertisement of the marketer, or has seen another person using the product).

It should be noted that while method 600 (and likewise system 200) are exemplified in many of the examples below with respect to Internet-based interactions and to advertising, they are not limited to such implementations.

Some examples of series of user interactions which include interactions with more than one user are: User A's ‘like’ can trigger an interaction for user B (thus two separate interactions); User B seeing that User A ‘liked’ a product or company on his Facebook® feed, and then clicking on the link; User B seeing an ad on Facebook® for a company or product and the ad informed him that his friend, User A ‘liked’ that company or product (this is also referred to as a social impression).

Other examples of cross-user interactions are possible, for example, social earned media—a user A fan event (e.g., ‘like’) may be displayed on his friend's (e.g., User B) social page feed (e.g., wall), causing user B to interact with the advertised content through an impression, and possible other, subsequent interactions.

The information obtained in stage 640 may pertain to all of the interactions of the series, or only to some of them. Hereinbelow it is assumed that the series only includes interactions for which information is obtained, and it is noted that an original series may be used to define a series that only includes interactions for which information is obtained.

As aforementioned, at least one of the interactions of the series includes communication of digital media over a network connection. Such interactions may include the previously offered examples or other types of interactions such as clicking or viewing by the user of an digital media advertisement, digital purchase of a product, and possibly digital transaction (e.g. provisioning of a purchased mp3 file), signing-in to a website or a service, social media interactions, e-mails, television advertisements, smart TV advertisements, and so on. However, the series of interactions may also include other types of interactions of which information is available, such as—mailing a physical catalogue to the user, identifying the user in a physical location (e.g. by location-based social networking such as “four Square™”), salestalk in a physical store, etc.

Stage 640 of obtaining information may include obtaining information pertaining to the individual interactions (e.g., information such as that exemplified above), and may also include obtaining information pertaining to groups of interactions (either the entire series or parts thereof). For example, information pertaining to groups of interactions may include statistics regarding the interactions (e.g., the amount of social media interactions, total time spent by the user in a website of the marketer in all of the interactions, average time between interactions, total number of interactions, time from first interaction to conversion etc.).

Stage 640 may include generating some or all of the information obtained, receiving some or all of the information obtained, and/or selecting some or all of the information obtained out of a larger database.

It is noted that method 600 may also include (e.g., as part of stage 640) defining the series of interactions. For example, such a stage of defining may include selecting a group of interactions out of a larger database of interactions. Similar to the discussion above, the defining of the series may include selecting a group which includes all of the interactions that comply to one or more selection criteria: e.g., interactions with a group of one or more identified users, interactions occurring within a predefined time frame, interactions over a group of one or more preselected advertising channels, interactions pertaining to a subgroup of advertised products but not to others, and so on.

Stage 650 of method 600 includes selecting an elect advertisement out of the plurality of optional advertisements based on the historical interactions data and on the performance information. Especially, stage 650 may include selecting the elect message on which to bid at the RTB server, based on the statistics of each of the optional advertisements (e.g. the performance information) and on the path of the user so far.

Optionally, method 600 may include stage 670 of determining a bid for one or more of the optional advertisements (and possibly for all of them) based on at least one of (a) the historical interactions data and (b) the performance information. Stage 670 includes stage 672 of determining a bid for the elect message based on at least one of: (a) the historical interactions data and (b) the performance information. Optionally, stage 672 may include determining the bid for the elect message based on the historical interactions data and the performance information.

It is noted that the determining of the bid (or bids) in stage 670 may affect the selection of one of the optional advertisements as the elect advertisements, and vice versa.

It will be clear to a person who is of skill in the art that the determining of the bid in stage 670 may depend on additional factors. Some of these factors may be financial factors (or other revenue or cost-related factors). For example, the determining of the bid which may be placed for the elect message may depend on the return-on-investment (ROI) expected from the suggested bid, the overall cost which may be allocated for the transmission of messages to users, and so on.

As discussed below, performance assessment may be computed as part of method 600, e.g. based on properties of the individual interactions of the series and/or on properties pertaining to more than one interaction of the series.

Optionally, stage 650 may include selecting the elect advertisement based on a calibrated selection scheme and on the properties relating to the at least one interaction out of the series of interactions. The selection scheme may be determined by a human expert but may also be determined by a computer processor (e.g., based on statistics of many series of interactions).

The determining of the bid (i.e. the amount of money or other type of valuable item which may be exchanged between parties, e.g. as a payment, such as goods or services) in stage 670 may be based on a bid determination scheme. All of the variations discussed below with respect to the selecting of stage 650 and/or to the selection scheme may also be implemented, mutatis mutandis, with respect to the determining of the bid in stages 670 and 672 and to the bid determination scheme respectively. In order to simplify the discussion, the selection scheme is discussed more thoroughly, and the discussion is not repeated with respect to the bid determination scheme.

As discussed below in greater detail, optionally the group of properties on which the selection of stage 650 is based includes at least one property which is unrelated to a time at which any of the interactions occurred. Specifically, in such a variation, at least one of the properties on which the selection of stage 650 is based is not related to any of the following:
a time at which any of the interactions occurred;
time passed between any two of more of the interactions of the series;
time passed between any of the interactions to another event or point in time;
relation of order between any two or more of the interactions of the series.

It is however noted that while not necessarily so, some of the properties of the interactions on which the selection of stage 650 is based may nevertheless be related to time (e.g., in addition to other properties such as the type of channel over which one or more of the interactions occurred).

As will be discussed below in greater detail, the computation of stage 650 may be based on various types of properties—each pertaining to a single interaction or to more than one interaction. Additionally, the selection of stage 650 may be based on additional information other than the properties which relate to the at least one interaction.

The interactions-related properties on which the computing of stage 650 is based do not pertain only (if at all) to the order of the interactions within the series. The computing is based on properties of the interactions such as (although not limited to) any combination of the following types of properties:
properties quantifying relative quality of the interaction, of types of communication or of advertisement channels used by the respective interaction;
properties of at least one subset of interactions of the series, the subset including multiple interactions (e.g., combinations—i.e., ordered or unordered sequences—of interactions of different types; amount of interactions of a given type in the entire series, temporal relations between interactions (generally or these of predefined types, etc.);
properties of elements that triggered interactions of the series (e.g., of a keyword in an interaction that involves keywords, e.g., the length of that keyword, whether such keyword includes or otherwise pertains to a pre-identified commercial brand or other advertised entity or not, etc.). By way of example, such keywords may indicate a type or classification of the conducted search (which involved the keywords). Such typing may refer to the scope of the search (whether this search was relatively broad/generic, e.g., a search for “cellular phone” relatively narrow/specific, e.g., a search for “Samsung Galaxy S3”). Another typing may pertain to the assumed purpose of the search (e.g., resembling a search in an index, for finding a known website, or for finding previously unknown information; navigational/non-navigational search);
properties which pertain to the creative media used in an advertisement involved in at least one of the respective interactions (e.g., copy, size, content, images, videos);
properties which pertain to an advertised entity associated with the interaction (e.g., properties pertaining to a commercial company, a brand, a product, a service, etc.);
properties which pertain to an advertisement provided to a user in the interaction;
properties which pertain to an estimated phase of a process-to-conversion model to which the interaction belongs (e.g., attention; interest; desire; action);
properties of the series of interactions which pertain to the order in which interactions of different types are ordered;
properties of the series of interactions which pertain to elapsed time between the interactions and between the interactions and conversions;
properties of the user, i.e., the ‘interactor’ (e.g., his personal characteristics, his location etc.);
properties of the platform used for the interaction (e.g., a mobile device, a desktop etc.)

As discussed below in greater detail, while the selecting of stage 650 may be based on the properties of individual interactions of the series, it may also be based on patterns of such properties across the series of interactions.

It is noted that some of the ways in which the properties of the different user interactions of the series may be utilized in stages 550, 650 and possibly in other stages (e.g. stage 580) are explored in U.S. patent application serial number 20120692071, entitled “System, Method and Computer Program Product for Prediction Based on User Interactions History” (publication number US2013204700), which is incorporated herein by reference in its entirety.

The computing of the performance assessment in stage 650 may be used for different uses, in different implementations of the invention. Possibly, the selecting of stage 650 may enable efficient utilization of communication resources, and/or of other types of resources. This efficient utilization of resources (and especially of the communication resources) may be part of method 600 (or, more generally, method 500), but this is not necessarily so. Such communication resources may include, for example, any combination of one or more of the following: advertising resources, communication hardware resources, communication channel resources, and so on).

As aforementioned, the selecting of the elect advertisement in stage 650 may be based on a selection scheme (which may be a “calibrated selection scheme”). The selection scheme on which the selecting of stage 650 may optionally be based may be implemented in different ways. A selection scheme is a set of one or more rules according to which the elect advertisement may be selected. Some selection schemes which may be implemented may include simple rules (e.g., “select a message which was not presented to the user for the longest period”), while other possible selection schemes may include substantially more complex rules. While some selection schemes may be strictly deterministic, others may include some random or semi-random aspects. In addition, a selection scheme may be determined by an expert, regardless of any specific statistical data, or based (solely or partly) on statistics of historical interaction logs.

A calibrated selection scheme is a selection scheme which is based on an analysis (e.g., a statistical analysis, possibly also linguistic analysis, etc.) of historical data which includes multiple series of interactions. Optionally, the historical data which is analyzed for the generation of the calibrated selection scheme may also include the historical outcomes of some or all of these series (e.g. which of these series ended up in a conversion and which did not, what were the physical dimensions of the output product in each of these series, and so on). The calibrated selection scheme is calibrated in that it pertains only to a series of interactions which fulfill a selection condition, and is used only to a series of interactions which fulfill the same selection condition.

For example, the following calibrated selection schemes pertain only to a series of interactions which fulfill the following conditions:
Series of interactions which are associated with a certain advertiser.
Series of interactions which are associated with a certain country or jurisdiction.
Series of interactions which are associated with a certain line of products of a given advertiser.
Series of interactions which are associated with a certain vertical.

Furthermore, the calibrated selection scheme may be a selection scheme which is based on an analysis of partial historical data (i.e., not of all of the available historical data) which is selected out of a larger log of historical data based on compliance of the selected series (and/or interactions) with one or more such selection rules.

For example, a log of historical data which pertains to a single advertiser may be divided based on the line of product (e.g., cellular phones vs. televisions), and each of these parts may be used for the generation of a respective calibrated selection scheme. Afterwards, an elect advertisement for a series of interactions which is associated with televisions would be selected based on the selection scheme calibrated based on the television-related historical data, while an elect advertisement for a series of interactions which is associated with cellular phones would be selected based on the selection scheme calibrated based on the cellular-phones-related historical data.

It is noted that the calibrated selection scheme may be updated from time to time based on new historical data. That is, method 500 may further include repeatedly updating the calibrated selection scheme (at regular intervals or otherwise), wherein each updating is based on historical data which is more recent than any of the previous instances of updating (that is, at least some of the historical data on which such updating is based is more recent than any of the previous instances of updating).

The analysis of the historical data may reflect, for example, causal relationships between interactions (interactions causing other interactions) and causal relationships between interactions and conversions. It is noted that the analysis may include analysis of series which did not contain conversions.

Stage 660 of method 600 includes transmitting information of the elect advertisement over a communication channel. Stage 660 may include transmitting the elect advertisement itself (e.g. the information of the elect advertisement transmitted is a content of the elect advertisement) or information pertaining to it (e.g. an identifier of the elect advertisement may be transmitted, thereby enabling another system such as the ad server to transmit the elect advertisement to the user). If stage 672 is executed, the transmitting of stage 660 may further include transmitting of the bid.

Reversion is now made to stages 650 and 670, and to the various kinds of properties which may be used in the process of selecting the elect message and/or in the process of determining the bid. As before, all of the variations discussed below with respect to the selecting of stage 650 and/or to the selection scheme may also be implemented, mutatis mutandis, with respect to the determining of the bid in stages 670 and 672 and to the bid determination scheme respectively. In order to simplify the discussion, the selection scheme is discussed more thoroughly, and the discussion is not repeated with respect to the bid determination scheme.

Optionally, the selecting may include selecting the elect message based on properties quantifying relative quality of the interactions. While different types of interactions (e.g., e-mails, telephone conversations, electronic advertisements, social media interactions, paper advertisements, videos watched, etc.) may be qualified by different types of quantities, many such quantified properties used for assessing quality of the interactions may be implemented, and in fact a significant variety is already used in the art. Offering only a few examples, such properties quantifying relative quality of the interactions may include:
Content of the interaction;
Duration of the interaction (e.g., time spent on website, duration of a phone conversation, percent of video length watched by the user, etc.);
Amount of data transferred to the client during the interaction (e.g., amount of web pages viewed);
Engagement of the user in the interaction (e.g., view, mouse-over, click in, click out)

Such properties quantifying relative quality of the interactions may also quantify relative quality of a group of interactions (e.g., interactions of the same type). For example, statistic products of the above example properties (e.g., minimum, maximum, average, median, mean, standard deviation, etc.). Other examples include:
Parameters qualifying response of user (or users) to such interactions (e.g., bounce rate);
Redundancy in interactions (e.g., times at which the interaction resulted from the same keyword entered by the user);

Optionally, the selecting may include selecting the elect message based on properties of at least one keyword entered by a user which triggered at least one interaction of the series.

Optionally, the selecting may include selecting the elect message based on properties which pertain to an advertisement provided to a user in at least one of the interactions of the series. Such properties pertaining to such an advertisement may be, for example, the type of the advertisement (e.g., video, non-video, image, animated-gif, text, etc.), duration of the advertisement, size of the advertisement (in centimeters, in pixels, etc.), an affectivity score of the advertisement (e.g., based on prior success/attribution analysis), its source (e.g., being sent from a friend, being included in a social-media feed, etc.), and so on.

Optionally, the selecting may include selecting the elect message based on types of communication channels used by the respective interactions. The types of communication may be analyzed in different resolutions. By way of example, a very coarse resolution is machine interactions vs. human interactions. A finer resolution would be the interactions technology used (e.g., e-mail, video, text ad, social-media, telephone, billboard). A yet finer resolution would differentiate, for example, between video advertisements embedded in an external website to video streamed at the website of the publisher, contextual display advertising, paid/non-paid advertising, and so on.

Optionally, the selecting may include selecting the elect message based on properties of elements that triggered interactions of the series. Interactions may be triggered by actions of the user who is a party of the interaction (e.g., by entering a keyword into a search engine), by the marketer (e.g., by sending a newsletter and/or an advertisement to a mailing list of users), or by actions of another user.

The properties pertaining to such elements (or events) may be, for example, parameters of the keyword entered (e.g., its length) or another element involved in the interaction, demographic parameters of a user (e.g., age, gender), and may also be meta-parameters such as—does the keyword include a brand-name of the marketer, does the keyword include a specific product name, manufacturer or model etc. Parameters which pertain to the event which triggered the interactions may be time of the event (e.g., the time of the day at which the keyword was entered by the user), the location of the event, etc. It should be noted that while not necessarily so, the event which triggered the interaction may be another interaction (which may be part of the series, but not necessarily so).

Optionally, the selecting may include selecting the elect message based on properties of at least one keyword entered by a user which triggered at least one interaction of the series.

Optionally, the selecting may include selecting the elect message based on properties which pertain to an advertised entity associated with one or more interactions of the series of interactions. The advertised entity may be the marketer himself (for example, such a property is whether the keyword includes the brand-name of the marketer), and may also be an advertised product or a service.

By way of example, the user may have ultimately purchased a certain type of product (say, a DELL computer). In view of this, advertisements which were presented to this user and which advertised totally unrelated products (e.g., shoes, razor blades, etc.) may be attributed smaller apportionments than advertisements (or other types of interactions) which are more relevant to the advertised entity (e.g., ones pertaining to computers, electronic gadgets, other DELL products, etc.).

Optionally, the selecting may include selecting the elect message based on properties of at least one subset of interactions of the series, wherein the subset includes multiple interactions. The subset of interactions may be defined in different ways.

For example, such properties of a subset of interactions may include:
Duration between two (or more) interactions of the subset;
Causal relations between two (or more) interactions of the subset;
Patterns occurring in at least one property of the interactions across the subset of interactions (e.g., considering the property Brand (B) vs. Non-Conversion (NB) as a type of a single interaction, the property of the subset that may be defined is whether the pattern NB-NB-NB-B occurs in the ordered subset);
The number of users that were a party to at least one of the interactions (and possibly the number of interactions having at least a predefined number of users participating therein).

It should be noted that the subset may be a proper subset of the series of interactions (i.e., include a smaller number of interactions), but in other alternatives it may include the entire series of interactions. Using the terminology of a path of interactions (also referred to as “conversion funnel”, “Path to conversion” or P2C, where applicable, or possibly also just as “Path”), the selecting may include selecting the elect message based on patterns occurring in at least one property of the interactions across the series of interactions, i.e., —across the path.

As aforementioned, the selecting of the elect message in stage 650 may be based on patterns which may be detected in the series of interactions.

If stage 660 includes transmitting information of the elect advertisement to a remote system such as the ad server (and optionally also the bid), the method may be followed by the following process, resulting in the displaying of the advertisement to the user:
In stage 660 the bid is transmitted to the ad exchange;
The exchange selects the highest bid with a URL of the winning ad (which preferably but not necessarily would be the elect advertisement) and returns that to the SSP;
SSP returns the winning bid to the ad server;
The ad server finally responds with an ad to the browser of the Internet user which started all these transactions.

Generally, using method 500 and/or method 600 for advertising may be implemented as follows: the determining the group of messages (in stage 520 or 620) includes determining a group of advertisable entities (e.g. advertisements, campaigns, etc.); the obtaining of the performance information (in stage 530 or 630) includes obtaining for each one of the plurality of optional messages click-through rate (CTR) information (whether estimated and/or historical); the obtaining of the historical interactions data (stage 540 or 640) includes obtaining data pertaining to advertisements previously communicated to the user; the selecting of the elect message (stage 550 or 650) includes selecting a selected advertisement; and the transmitting of the information of the elect message (stage 560 or 660) includes transmitting to a real-time bidding server a bid for displaying the selected advertisement to the user.

Generally, using method 500 and/or method 600 for advertising may be implemented as follows: the group of messages includes advertisable entities; the performance information includes click-through rate (CTR) information for each one of the plurality of optional advertisable entities; the historical interactions data includes data pertaining to advertisements previously communicated to the user; the elect message is an elect advertisement; and the transmitting includes transmitting to a real-time bidding server a bid for displaying the elect advertisement to the user.

Reverting to method 500, following is a discussion which details some of the optional variations of method 500 when implemented for transmitting of messages which include digital media to Internet users.

Users use the Internet in many forms and ways. For example, the user may surf the web in a habitual way (e.g. using social networks, watching videos and listening to music, reading the news) or in a target-oriented way (e.g. looking for details regarding a product which the user considers buying). Tracking the activities of the user when surfing the world-wide web (WWW) may enable logging information which is indicative of the interests of the user and also information which is indicative of present time intentions of the user.

For example, obtaining in stage 540 historical interactions data which pertains to interactions of the user which included surfing in various websites may enable to base the selecting of elect message in stage 550 on the interest of the user. For example, if in the preceding months the user frequented websites which relate to gardening, the selection of the elect message out of the optional messages may include selecting a message which relates to gardening.

It is noted that the same data may be used not only for the selection of the elect message in stage 550, but also for the determining of the group of messages in stage 520.

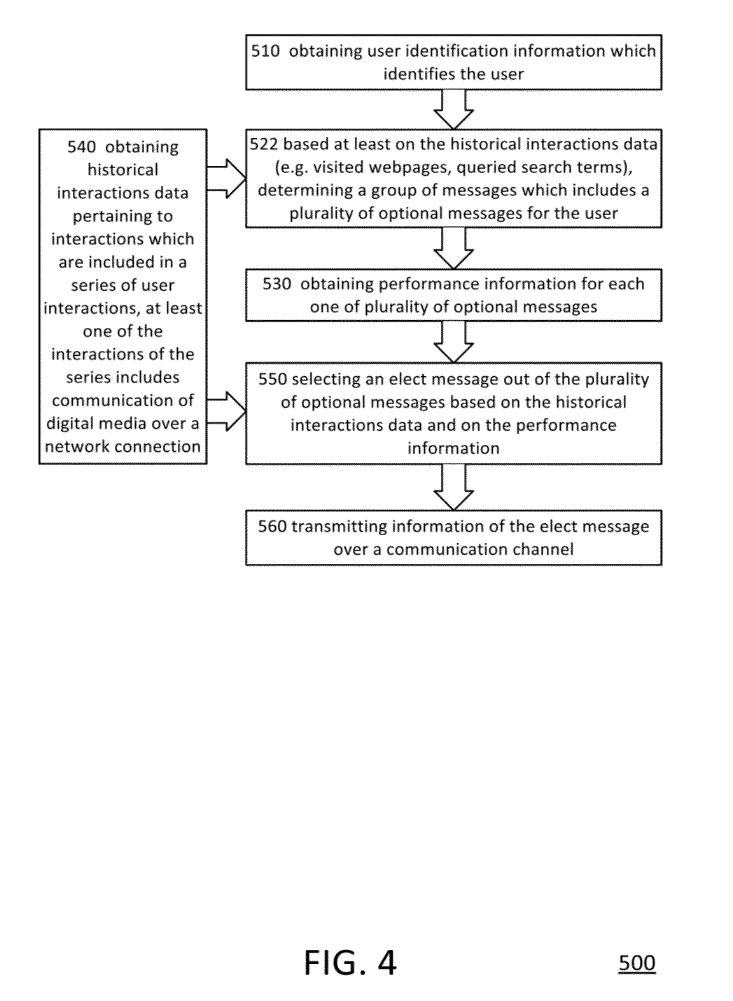

Referring to FIG. 4 (which is a generalized flow chart of method 500 in accordance with the subject matter of the present invention), generally, the determining of the group of messages (in stage 520) may optionally be based on the historical interactions data (as exemplified in FIG. 4 in stage 522, which may be implemented as part of stage 520). It is noted that different parts of the historical data may be used in stage 520 and in stage 550 (i.e. not all historical interactions data used for the determining of stage 520 is necessarily used in the selecting of stage 550, and vice versa). Similar variation may also be implemented for method 600.

For example, obtaining in stage 540 historical interactions data which pertains to interactions of the user which included surfing in various websites may enable to base the determining of the group of messages in stage 520 on the interest of the user. For example, if in the preceding months the user frequented websites which relate to gardening, the determining of the group of messages may include determining a group of messages which include one or more optional messages which relate to gardening.

The determining of the group of messages in stage 520 may be based on past visits of the user to one or more identified websites, such as advertiser's sites, product pages, and so on.

As aforementioned, the historical interactions data may also be used in additional ways. For example, the determining of the group of messages in stage 520 (e.g. in stage 522) may optionally be based on information from the historical interactions data which is indicative of at least one query (e.g. a search term, or a search phrase) submitted by the user.

For example, obtaining in stage 540 historical interactions data which pertains to interactions of the user which included searching in a search engines using queries which relate to a product or other object of interest may enable to base the determining of the group of messages (stage 520) and/or the selecting of elect message (stage 550) on the intent of the user.

For example, if in the preceding days the user queried one or more search engines using search terms which relate to sunglasses, the determining of the group of messages may include determining a group of message which includes one or more messages (e.g. advertisements) which relate to sunglasses (or more generally to fashion, depending on the availability of sunglasses-related message). In a similar example, if in the preceding days the user queried one or more search engines using search terms which relate to sunglasses, the selection of the elect message (e.g. advertisement) out of the optional messages may include selecting a message which relates to sunglasses (or more generally to fashion, depending on the availability of sunglasses-related message).

However, intent of the user may be deduced from other information as well. For example, if the user spent time in a price-comparison website which compares the prices of telephones, it is likely that the user has a relative high intent to purchase a telephone in the near future.

It is noted that the determining of the group of messages may be based both on intent of the user and on general interests of the user. Optionally, the determining of the group of messages may be based on the historical interactions data which includes data pertaining to webpages accessed by the user and to at least one query submitted by the user.

Referring to stage 550 (and to stage 650), it is noted that the selecting of the elect message may be based on which messages were previously communicated to the user. For example, if the user recently received a certain message, the selecting may disfavor selecting the same message—or even a similar one—again. For example, if the user received advertisements for sunglasses and for gardening in the last 24 hours, an advertisement for a different product (e.g. a vacation) may be selected in stage 650, even if the expected revenue from displaying this advertisement would otherwise be considered lower.

Generally, the plurality of optional messages may include messages from two or more nonoverlapping sets of messages (e.g. one set of advertisements for gardening products and another set of advertisements for vacations). Such a set of advertisements may be a campaign, but other criteria of grouping may also be implemented (e.g. different sizes etc. of messages of the same content).

The selecting of the elect message in such cases may optionally be based on times at which messages of different sets out of the nonoverlapping sets of messages were communicated to the user. For example, the group of advertisements may include three advertisements, and the selection of the advertisement to be transmitted may depend on past advertising history (i.e. depending on the ads previously presented to the user).

Significantly, the times at which different messages were communicated to the user may be used to determine not to communicate any message to the user in the present (e.g. for a specific real-time bidding request). For example, if similar messages to the plurality of optional messages were already communicated to the user recently, in some cases it may make no sense to communicate to the user a similar message shortly thereafter, while in others instances it may be the opposite.

For example, if the user was looking in a search engine for a washing machine, and an advertisement for a washing machine has already been presented to the user 10 minutes prior to that, the outcome of considering the historical interaction data (and possibly also the performance information) may be a decision not to present to the user another advertisement for a washing machine, but to rather wait for a later time, because the marginal value from an additional advertisement is not expected to be very high and may even impair the conversion rate.

It will however be clear to a person who is of skill in the art that other considerations may also affect the selecting of the elect message—in addition to the historic use of the messages, or in its stead.

For example, the selecting of the elect message in stage 550 (and in stage 650) may be based on a value of advertisement, such as the expected revenue from displaying it to the specific user.

Generally, different valuations may be assigned to different optional messages out of the plurality of optional messages. Such valuations may be monetary ones, but not necessarily so. For example, such a valuation may also be an amount of another type of valuable item which may be exchanged between parties, e.g. as a payment, such as goods or services.

The selecting of the elect message in such a case may further be based on the valuations assigned to the plurality of optional messages. Obviously, the bid determined in stage 670 (if implemented) may also be based on valuations assigned to the plurality of optional messages.

It is noted that method 500 (as well as method 600) may also include assigning the valuations to the plurality of optional messages based on the historical interactions data. It is noted that ways in which valuations may be assigned to optional messages based on the historical interactions data are discussed in U.S. patent application serial number 20120692071, entitled “System, Method and Computer Program Product for Prediction Based on User Interactions History” (publication number US2013204700), which is incorporated herein by reference in its entirety.

It is noted that a valuation may also be assigned to the user himself, and not only to the message. For example, some users may be considered as closer to conversion than others (at least with respect to some groups of products). Such a valuation of users may be useful for the determining of the bid in optional stage 670, and possibly also for the selecting of the elect message in stage 550 and/or for the determining of the group of messages in stage 520 (and the corresponding stage 650 and stage 620, respectively).

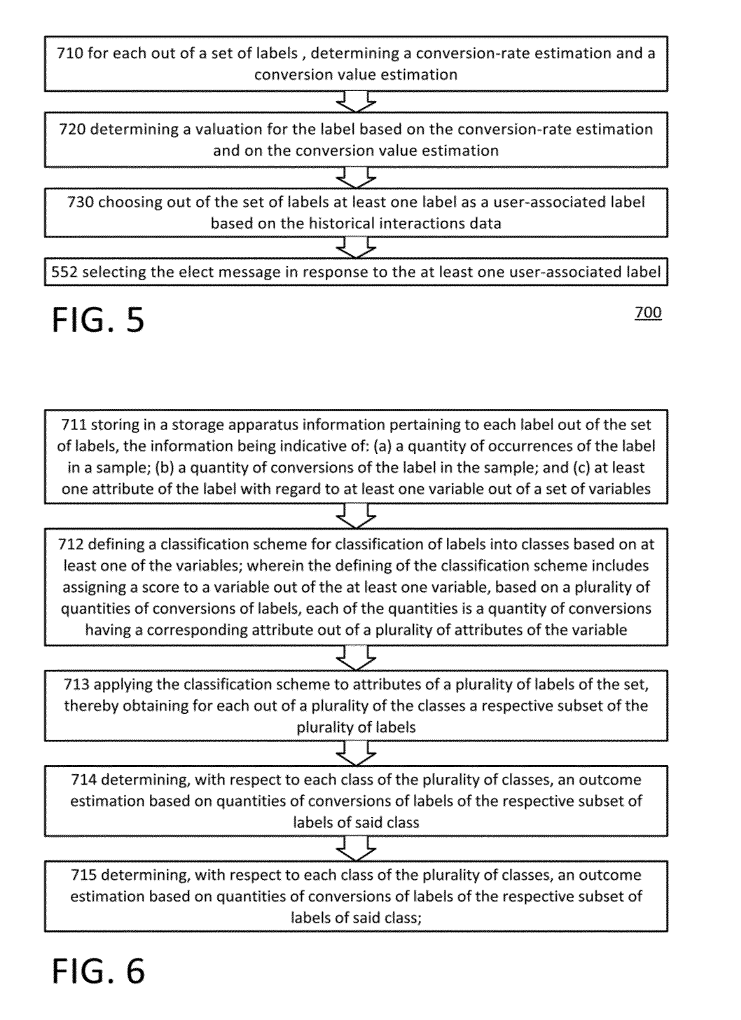

One of the different processes which may be used within the scope of the present invention for assigning a valuation to the user is discussed below, with respect to FIG. 5 (denoted process 700). It is however noted that other processes may also be implemented.

Stage 710 of process 700 includes determining for each label out of a set of labels a conversion-rate estimation for the label and a conversion value estimation for the label. Stage 720 which follows stage 710 includes determining for each such label a valuation, based on the conversion-rate estimation and on the conversion value estimation determined for this label.

For example, each label may be a keyword (e.g. sunglasses, wheelbarrows, Italy vacations, etc.). The conversion value estimation determined for each of the labels may be an estimated revenue per conversion. For example, a conversion which includes purchase of a pair of shoes may be associated with an estimated revenue of $100, while a conversion which includes purchase of a flight and a hotel stay in Italy may be associated with an estimated revenue of $3,000.

It is noted that each keyword may be associated with many items which may be selected by the user (for example, the keyword “Italy vacations” may be associated with a plurality of webpages that may be accessed by the user and/or with a plurality of queries that may be entered by the user—e.g. “Venice”, “Florence hotels”, etc.).

Stage 730 of process 700 includes choosing out of the set of labels at least one label as a user-associated label (i.e. a label which is associated with the user) based on the historical interactions data. For example, the choosing of the user-associated label may include choosing a label which is associated with the last search engine query used by the user in the series of interactions. More sophisticated approaches may also be used. For example, if the last query of the user pertained to pencils and the one before that pertained to cars, it may be more beneficial to choose “car” as the user associated label. That is, the choosing of the user-associated label may be based on conversion value estimations associated with a plurality of labels which are suggested by the historic interactions data (e.g. search queries and webpages from the last 24 hours). This may include choosing the label associated with the highest conversion value estimation, choosing one of the labels associated with the few highest conversion value estimations, and so on. Generally, the choosing of the at least one user-associated label may include choosing between multiple labels which are associated with interactions of the series of interactions.

If process 700 is executed, the selecting of the elect message in stage 550 is executed after stage 730 is carried out, and it includes stage 552 of selecting the elect message in response to the at least one user-associated label. This may be done directly or indirectly (e.g. by assigning a valuation to the user and, based upon it, selecting the elect message). Stage 670 (if executed) may also be based on the results of stage 730.

The choosing of the user-associated label may be based on the query that the user typed to the search engine or while engaging in other digital interactions such as social networks. For example, the following parameters regarding this query may be used as a basis for the choosing:
1. The context of the query (which campaign, which search engine was used, what is the targeting of the relevant campaign).
2. The performance behind the KW.
3. The text of the query itself

For example, consider the following queries:
Query 1: “new kitchen” in Google from kitchen campaign that targets California
Query 2: “shelf” in Bing from kitchen campaign that targets Alaska

Query 1 may result in assigning to the user a valuation which is 10 times larger than the valuation that would have been assigned to Query 2.

Optionally, stage 710 may be carried out according to any one of the methods discussed in U.S. patent application serial number 20130212108 by Armon-Kest, Gilad, et al., entitled “System, a Method and a Computer Program Product for Performance Assessment”, which is incorporated herein by reference in its entirety.

FIG. 6 is a generalized flow chart of a process for executing stage 710 of method 700, in accordance with the subject matter of the present invention. For example, stage 710 of determining of the conversion-rate estimation for each out of the set of labels may include:

Stage 711 of storing in a storage apparatus information pertaining to each label out of the set of labels, the information being indicative of: (a) a quantity of occurrences of the label in a sample; (b) a quantity of conversions of the label in the sample; and (c) at least one attribute of the label with regard to at least one variable out of a set of variables (wherein the quantity of occurrences of at least one of the labels is larger than one).

Stage 712 of defining a classification scheme for classification of labels into classes based on at least one of the variables; wherein the defining of the classification scheme includes assigning a score to a variable out of the at least one variable, based on a plurality of quantities of conversions of labels, each of the quantities is a quantity of conversions having a corresponding attribute out of a plurality of attributes of the variable;

Stage 713 of applying the classification scheme to attributes of a plurality of labels of the set, thereby obtaining for each out of a plurality of the classes a respective subset of the plurality of labels;

Stage 714 of determining, with respect to each class of the plurality of classes, an outcome estimation based on quantities of conversions of labels of the respective subset of labels of the class;

and stage 715 of computing for each label of the set of labels a conversion rate estimation which is based on an outcome estimation of a class out of the classes that is a result of application of the classification scheme to attributes of the analyzed label.

It is noted that other algorithms for determining the conversion-rate estimations for the various labels may be used, such as linguistic algorithms.

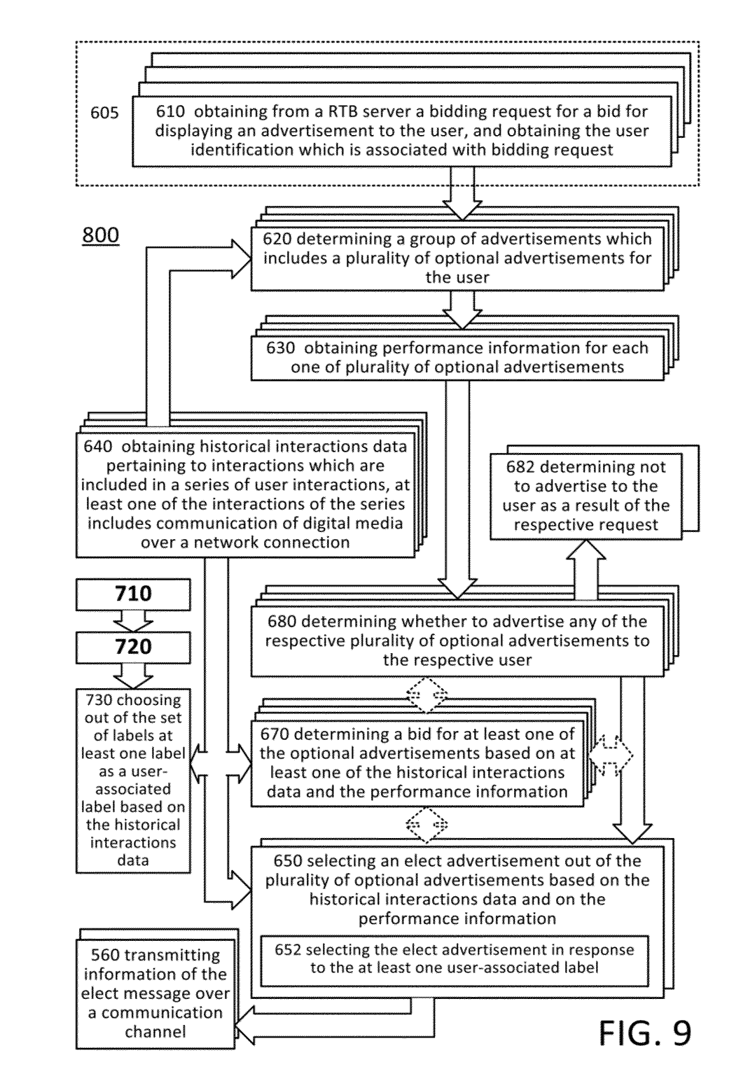

It is noted that while different details have been provided with respect to different figures, and that methods have been given different names, all of the different stages and variations belong to the same general method, and may be combined. For example, FIG. 9 is a generalized flow chart of a method 800, which is a computerized method which implements method 500 for communication of digital media with a user, in accordance with the subject matter of the present invention. Method 800 is just one example in which different stages discussed with respect to different drawings may be combined.

FIG. 7 is a functional block diagram of system 200, which is a system for communication in accordance with the presently disclosed subject matter. System 200 includes at least a communication interface (denoted 220) and a non-transitory processor (denoted 210), but may also include other components such as power source 230 and/or intangible memory storage medium 240 from which processor 210 may read and write data.

Non-transitory processor 210 is configured at least to: (a) determine a group of messages including a plurality of optional messages for a user in response to obtaining of user identification information identifying the user; (b) obtain performance information for each one of plurality of optional messages; (c) obtain historical interactions data pertaining to interactions which are included in a series of user interactions, wherein at least one of the interactions of the series includes communication of digital media over a network connection to the user; and (d) select an elect message out of the plurality of optional messages based on the historical interactions data and on the performance information.

Communication interface 220 is operable and configured to transmit information of the elect message over a communication channel. Optionally, communication interface 220 may also be operable and configured to receive the user identification information which identifies the user from an external system. For example, communication interface 220 may be configured and operable to receive from a RTB sever a bid request which identifies the user.

Optionally, system 220 may be is an advertising system, in which: processor 210 is configured to select, based on the historical interactions data and on the performance information, an elect advertisement out of the group of messages which comprises a plurality of optional advertisement; and communication interface 220 is configured and operable to obtain the user identification information identifying the user in a bidding request for a bid for displaying an advertisement to the user which is received from a real-time bidding (RTB) server; and to transmit information of the elect advertisement over the communication channel.

It is noted that processor 210 may be configured to execute any one or more of stages 510 through 560 and 610 through 660 (and possibly also stage 670) and their variations. Below are but just a few examples.

Optionally, processor 210 may be configured to determine the group of messages based on at least one query submitted by the user.

Optionally, processor 210 may be configured to determine the group of messages based on information from the historical interactions data which is indicative of at least one query submitted by the user.

Optionally, processor 210 may be configured to determine the group of messages based on the historical interactions data.

Optionally, the plurality of optional messages may include messages from two or more non-overlapping sets of messages, wherein processor 210 may be configured to select the elect message based on times at which messages of different sets out of the non-overlapping sets of messages were communicated to the user.

Optionally, different valuations are assigned to different optional messages out of the plurality of optional messages; wherein processor 210 may be configured to select the elect message further based on the valuations assigned to the plurality of optional messages.

Optionally, processor 210 may be further configured to assign the valuations to the plurality of optional messages based on the historical interactions data.

Optionally, processor 210 may be further configured to determine a bid for the elect message based on at least one of: (a) the historical interactions data and (b) the performance information, wherein the transmitting further includes transmitting the bid.

Optionally, processor 210 may be configured to determine the bid for the elect message based on: (a) the historical interactions data and (b) the performance information.

Optionally, processor 210 may be configured to execute: (a) for each out of a set of labels, determining a conversion-rate estimation and a conversion value estimation, and determining a valuation for the label based on the conversion-rate estimation and on the conversion value estimation; and (b) choosing out of the set of labels at least one label as a user-associated label based on the historical interactions data. Processor 210 may also be configured to select the elect message in response to the at least one user-associated label.

Optionally, processor 210 may be operable and configured to receive a plurality of requests, each of the requests including user identification information identifying a respective user, and, with respect to each one of the requests: (a) determining a respective group of messages which includes a respective plurality of optional messages for the respective user; (b) obtaining performance information for each one of the respective plurality of optional messages; (c) obtaining historical interactions data pertaining to interactions which are included in a respective series of user interactions associated with the respective user, wherein at least one of the interactions of the series includes communication of digital media over a network connection to the respective user; and (d) determining whether to initiate communication of any of the respective plurality of optional messages to the respective user; thereby determining not to initiate communication with any user as a result of at least one of the plurality of requests. Processor 210 in such a case may be further operable and configured to select one the elect message in response to determining to initiate communication with the user that is identified in at least one of the plurality of requests.

Alternatively to the example shown in FIG. 7, system 100 may in some examples include fewer, more and/or different modules than shown in FIG. 7. Alternatively to the example shown in FIG. 1, the functionality of system 100 may in some examples be divided differently among the modules illustrated in FIG. 7. Alternatively to the example shown in FIG. 1, the functionality of system 100 described herein may in some examples be divided into fewer, more and/or different modules than shown in FIG. 7 and/or system 100 may in some examples include additional, less, and/or different functionality than described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing any of the disclosed methods 500, 600, 700 and 800, and any combination thereof, including any of the variations discussed with respect to these methods. The presently disclosed subject matter further contemplates a machine-readable memory tangibly embodying a program of instructions executable by the machine for executing any of the disclosed methods 500, 600, 700 and 800, and any combination thereof, including any of the variations discussed with respect to these methods.

It will also be understood that the system according to the invention may be a suitably programmed computer. Likewise, the invention contemplates a computer program being readable by a computer for executing any of the disclosed methods 500, 600, 700 and 800, and any combination thereof, including any of the variations discussed with respect to these methods. The invention further contemplates a machine-readable memory tangibly embodying a program of instructions executable by the machine for executing any of the disclosed methods 500, 600, 700 and 800, and any combination thereof, including any of the variations discussed with respect to these methods.

For example, a non-volatile program storage device readable by machine, tangibly embodying a program of instructions executable by the machine to perform a method for communication with a user which includes the steps of: (a) in response to obtaining of user identification information identifying the user, determining a group of messages including a plurality of optional messages for the user; (b) obtaining performance information for each one of plurality of optional messages; (c) obtaining historical interactions data pertaining to interactions which are included in a series of user interactions, wherein at least one of the interactions of the series includes communication of digital media over a network connection to the user; (d) selecting an elect message out of the plurality of optional messages based on the historical interactions data and on the performance information; and (e) transmitting information of the elect message over a communication channel.

It is noted that the aforementioned computer readable code and programmed computer may be implemented according to any one of the variations discussed with respect to any of the disclosed methods 500, 600, 700 and 800, and any combination thereof, including any of the variations discussed with respect to these methods, even though not explicitly elaborated for reasons of brevity of the disclosure.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A computerized method for communication with a user, comprising:
in response to obtaining of user identification information identifying the user, determining a group of messages comprising a plurality of optional messages for the user;
obtaining performance information for each one of plurality of optional messages;
obtaining historical interactions data pertaining to interactions which are included in a series of user interactions, wherein at least one of the interactions of the series comprises communication of digital media over a network connection to the user; and
selecting an elect message out of the plurality of optional messages based on the historical interactions data and on the performance information; and
transmitting information of the elect message over a communication channel.

2. A computerized method for advertising, the method comprising:
obtaining from a real-time bidding (RTB) server a bidding request for a bid for displaying an advertisement to the user, and obtaining the user identification which is associated with the bidding request; and
executing the computerized method of claim 1 for transmitting information of the elect message, wherein the elect message is an advertisement selected out of a group of advertisements based on the historical interactions data.

3. The method according to claim 1, wherein the determining of the group of messages is based on information from the historical interactions data which is indicative of at least one query submitted by the user.

4. The method according to claim 1, wherein the determining of the group of messages is based on the historical interactions data.

5. The method according to claim 1, wherein the determining of the group of messages is based on past visits of the user to one or more identified websites.

6. The method according to claim 1, wherein the plurality of optional messages may include messages from two or more nonoverlapping sets of messages, wherein the selecting of the elect message is based on times at which messages of different sets out of the nonoverlapping sets of messages were communicated to the user.

7. The method according to claim 1, wherein different valuations are assigned to different optional messages out of the plurality of optional messages wherein the selecting of the elect message is further based on the valuations assigned to the plurality of optional messages.

8. The method according to claim 7, further comprising assigning the valuations to the plurality of optional messages, wherein the assigning is based on the historical interactions data.

9. The method according to claim 1, further comprising determining a bid for the elect message based on at least one of: (a) the historical interactions data and (b) the performance information, wherein the transmitting further comprises transmitting the bid.

10. The method according to claim 1, wherein the group of messages comprises advertisable entities;
wherein the performance information comprises click-through rate (CTR) information for each one of the plurality of optional advertisable entities;
wherein the historical interactions data comprises data pertaining to advertisements previously communicated to the user;
wherein the elect message is an elect advertisement;
wherein the transmitting comprises transmitting to a real-time bidding server a bid for displaying the elect advertisement to the user.

11. The method according to claim 1, comprising:
for each label out of a set of labels, obtaining a conversion-rate estimation and a conversion value estimation;
determining a valuation for the label based on the conversion-rate estimation and on the conversion value estimation; and
choosing out of the set of labels at least one label as a user-associated label based on the historical interactions data;
wherein the selecting of the elect message is responsive to the at least one user-associated label.

12. The method according to claim 11, wherein the obtaining of the conversion-rate estimation for each one out the set of labels comprises:
storing in a storage apparatus information pertaining to each label out of the set of labels, the information being indicative of: (a) a quantity of occurrences of the label in a sample; (b) a quantity of conversions of the label in the sample; and (c) at least one attribute of the label with regard to at least one variable out of a set of variables; wherein the quantity of occurrences of at least one of the labels is larger than one;
defining a classification scheme for classification of labels into classes based on at least one of the variables; wherein the defining of the classification scheme includes assigning a score to a variable out of the at least one variable, based on a plurality of quantities of conversions of labels, each of the quantities is a quantity of conversions having a corresponding attribute out of a plurality of attributes of the variable;
applying the classification scheme to attributes of a plurality of labels of the set, thereby obtaining for each one out of a plurality of the classes a respective subset of the plurality of labels;
determining, with respect to each class of the plurality of classes, an outcome estimation based on quantities of conversions of labels of the respective subset of labels of the class; and
computing for each label of the set of labels a conversion rate estimation which is based on an outcome estimation of a class out of the classes that is a result of application of the classification scheme to attributes of the analyzed label.

13. The method according to claim 11, wherein the choosing of the least one user-associated label comprises choosing between multiple labels which are associated with interactions of the series of interactions.

14. The method according to claim 1, comprising: for at least one of the plurality of optional messages, determining a valuation for that optional message based on timing of one or more interactions of the series of user interactions.

15. The method according to claim 1, wherein the selecting of the elect message is preceded by receiving a plurality of requests, each of the requests comprising user identification information identifying a respective user, and, with respect to each one of the requests:
(a) determining a respective group of messages which comprises a respective plurality of optional messages for the respective user;
(b) obtaining performance information for each one of the respective plurality of optional messages;
(c) obtaining historical interactions data pertaining to interactions which are included in a respective series of user interactions associated with the respective user, wherein at least one of the interactions of the series comprises communication of digital media over a network connection to the respective user; and
(d) determining whether to initiate communication of any of the respective plurality of optional messages to the respective user;
thereby determining not to initiate communication with any user as a result of at least one of the plurality of requests;
wherein the selecting of the elect message is executed in response to determining to initiate communication with the user that is identified in at least one of the plurality of requests.

16. The method according to claim 15, wherein user identification information that identifies the user is comprised in at least one early request out of the plurality of requests and in at least one later request out of the plurality of requests, wherein the method comprises determining not to initiate communication with the user in response to the early request, and determining to initiate communication with the user in response to the later request.

17. A system for communication, comprising:
a non-transitory processor configured to:
determine a group of messages comprising a plurality of optional messages for a user in response to obtaining of user identification information identifying the user,
obtain performance information for each one out of a plurality of optional messages;
obtain historical interactions data pertaining to interactions which are included in a series of user interactions, wherein at least one of the interactions of the series comprises communication of digital media over a network connection to the user; and
select an elect message out of the plurality of optional messages based on the historical interactions data and on the performance information; and
a communication interface operable and configured to transmit information of the elect message over a communication channel.

18. The system according to claim 1, wherein the system is an advertising system, wherein:
the processor is configured to select, based on the historical interactions data and on the performance information, an elect advertisement out of the group of messages which comprises a plurality of optional advertisement;
wherein the communication interface is configured and operable to obtain the user identification information identifying the user in a bidding request for a bid for displaying an advertisement to the user which is received from a real-time bidding (RTB) server; and to transmit information of the elect advertisement over the communication channel.

19. The system according to claim 17, wherein the processor is configured to determine the group of messages based on information from the historical interactions data which is indicative of at least one query submitted by the user.

20. The system according to claim 17, wherein the plurality of optional messages may include messages from two or more nonoverlapping sets of messages, wherein the processor is configured to select the elect message based on times at which messages of different sets out of the nonoverlapping sets of messages were communicated to the user.

21. The system according to claim 17, wherein different valuations are assigned to different optional messages out of the plurality of optional messages; wherein the processor is configured to select the elect message further based on the valuations assigned to the plurality of optional messages.

22. The system according to claim 17, wherein the processor is further configured to determine a bid for the elect message based on at least one of: (a) the historical interactions data and (b) the performance information, wherein the transmitting further comprises transmitting the bid.

23. The system according to claim 17, wherein the processor is configured to execute:
for each out of a set of labels, determine a conversion-rate estimation and a conversion value estimation, and determine a valuation for the label based on the conversion-rate estimation and on the conversion value estimation; and
choose out of the set of labels at least one label as a user-associated label based on the historical interactions data;
wherein the processor is configured to select the elect message in response to the at least one user-associated label.

24. The system according to claim 17, wherein the processor is operable and configured to receive a plurality of requests, each of the requests comprising user identification information identifying a respective user, and to execute with respect to each one of the requests:
(a) determining a respective group of messages which comprises a respective plurality of optional messages for the respective user;
(b) obtaining performance information for each one of the respective plurality of optional messages;
(c) obtaining historical interactions data pertaining to interactions which are included in a respective series of user interactions associated with the respective user, wherein at least one of the interactions of the series comprises communication of digital media over a network connection to the respective user; and
(d) determining whether to initiate communication of any of the respective plurality of optional messages to the respective user;
thereby determining not to initiate communication with any user as a result of at least one of the plurality of requests;
wherein the processor is operable and configured to select the elect message in response to determining to initiate communication with the user that is identified in at least one of the plurality of requests.

25. A non-volatile program storage device readable by machine, tangibly embodying a program of instructions executable by the machine to perform a method for communication with a user which comprises the steps of:
in response to obtaining of user identification information identifying the user, determining a group of messages comprising a plurality of optional messages for the user;
obtaining performance information for each one of plurality of optional messages;
obtaining historical interactions data pertaining to interactions which are included in a series of user interactions, wherein at least one of the interactions of the series comprises communication of digital media over a network connection to the user; and
selecting an elect message out of the plurality of optional messages based on the historical interactions data and on the performance information; and
transmitting information of the elect message over a communication channel.

26. A non-volatile program storage device readable by machine, tangibly embodying a program of instructions executable by the machine to perform a method for advertising to a user which comprises the steps of:
obtaining from a real-time bidding (RTB) server a bidding request for a bid for displaying an advertisement to the user, and obtaining the user identification which is associated with the bidding request; and
executing the steps of claim 25 for transmitting information of the elect message, wherein the elect message is an advertisement selected out of a group of advertisements based on the historical interactions data.

27. The program storage device according to claim 25, wherein the determining of the group of messages is based on information from the historical interactions data which is indicative of at least one query submitted by the user.

28. The program storage device according to claim 25, wherein the determining of the group of messages is based on past visits of the user to one or more identified websites.

29. The program storage device according to claim 25, wherein the plurality of optional messages may include messages from two or more nonoverlapping sets of messages, wherein the selecting of the elect message is based on times at which messages of different sets out of the nonoverlapping sets of messages were communicated to the user.

30. The program storage device according to claim 25, wherein different valuations are assigned to different optional messages out of the plurality of optional messages wherein the selecting of the elect message is further based on the valuations assigned to the plurality of optional messages.

31. The program storage device according to claim 32, further comprising instructions for assigning the valuations to the plurality of optional messages, wherein the assigning is based on the historical interactions data.

32. The program storage device according to claim 25, further comprising instructions for determining a bid for the elect message based on at least one of: (a) the historical interactions data and (b) the performance information, wherein the transmitting further comprises transmitting the bid.

33. The program storage device according to claim 25, wherein the group of messages comprises advertisable entities;
wherein the performance information comprises click-through rate (CTR) information for each one of the plurality of optional advertisable entities;
wherein the historical interactions data comprises data pertaining to advertisements previously communicated to the user;
wherein the elect message is an elect advertisement;
wherein the transmitting comprises transmitting to a real-time bidding server a bid for displaying the elect advertisement to the user.

34. The program storage device according to claim 25, comprising instructions for:
for each label out of a set of labels, obtaining a conversion-rate estimation and a conversion value estimation;
determining a valuation for the label based on the conversion-rate estimation and on the conversion value estimation; and
choosing out of the set of labels at least one label as a user-associated label based on the historical interactions data;
wherein the selecting of the elect message is responsive to the at least one user-associated label.

35. The program storage device according to claim 34, wherein the obtaining of the conversion-rate estimation for each one out of the set of labels comprises:
storing in a storage apparatus information pertaining to each label out of the set of labels, the information being indicative of: (a) a quantity of occurrences of the label in a sample; (b) a quantity of conversions of the label in the sample; and (c) at least one attribute of the label with regard to at least one variable out of a set of variables; wherein the quantity of occurrences of at least one of the labels is larger than one;
defining a classification scheme for classification of labels into classes based on at least one of the variables; wherein the defining of the classification scheme includes assigning a score to a variable out of the at least one variable, based on a plurality of quantities of conversions of labels, each of the quantities is a quantity of conversions having a corresponding attribute out of a plurality of attributes of the variable;
applying the classification scheme to attributes of a plurality of labels of the set, thereby obtaining for each one out of a plurality of the classes a respective subset of the plurality of labels;
determining, with respect to each class of the plurality of classes, an outcome estimation based on quantities of conversions of labels of the respective subset of labels of the class; and
computing for each label of the set of labels a conversion rate estimation which is based on an outcome estimation of a class out of the classes that is a result of application of the classification scheme to attributes of the analyzed label.

36. The program storage device according to claim 34, wherein the choosing of the at least one user-associated label comprises choosing between multiple labels which are associated with interactions of the series of interactions.

37. The program storage device according to claim 25, comprising instructions for: for at least one of the plurality of optional messages, determining a valuation for that optional message based on timing of one or more interactions of the series of user interactions.

38. The program storage device according to claim 25, wherein the selecting of the elect message is preceded by receiving a plurality of requests, each of the requests comprising user identification information identifying a respective user, and wherein the program storage device further comprises instructions with respect to each one of the requests, for:
(a) determining a respective group of messages which comprises a respective plurality of optional messages for the respective user;
(b) obtaining performance information for each one of the respective plurality of optional messages;
(c) obtaining historical interactions data pertaining to interactions which are included in a respective series of user interactions associated with the respective user, wherein at least one of the interactions of the series comprises communication of digital media over a network connection to the respective user; and
(d) determining whether to initiate communication of any of the respective plurality of optional messages to the respective user;
thereby determining not to initiate communication with any user as a result of at least one of the plurality of requests;
wherein the selecting of the elect message is executed in response to determining to initiate communication with the user that is identified in at least one of the plurality of requests.

39. The program storage device according to claim 38, wherein user identification information that identifies the user is comprised in at least one early request out of the plurality of requests and in at least one later request out of the plurality of requests, wherein the program storage device comprises instructions for determining not to initiate communication with the user in response to the early request, and determining to initiate communication with the user in response to the later request.
